(19) United States
(12) Patent Application Publication
(10) Pub. No.: US 2005/0060643 A1
(43) Pub. Date: Mar. 17, 2005

(54) DOCUMENT SIMILARITY DETECTION AND CLASSIFICATION SYSTEM

(75) Inventors: JEFFREY BRIAN GLASS, Castro Valley, CA (US); ELIZABETH DERR, Richmond, CA (US)

Correspondence Address: Jeffrey Brian Glass, 4492 Hillsborough Drive, Castro Valley, CA, 94546, US

(73) Assignee: MiaVia, Inc., Castro Valley, CA (US)

(21) Appl. No.: 10/710,918

(22) Filed: Aug. 12, 2004

Related U.S. Application Data
(60) Provisional application No. 60/481,283, filed on Aug. 25, 2003.

(51) Int. Cl. G06F 17/24

(52) U.S. Cl. 715/501.1

(57) ABSTRACT

A document similarity detection and classification system is presented. The system employs a case-based method of classifying electronically distributed documents in which content chunks of an unclassified document are compared to the sets of content chunks comprising each of a set of previously classified sample documents in order to determine a highest level of resemblance between an unclassified document and any of a set of previously classified documents. The sample documents have been manually reviewed and annotated to distinguish document classifications and to distinguish significant content chunks from insignificant content chunks. These annotations are used in the similarity comparison process. If a significant resemblance level exceeding a predetermined threshold is detected, the classification of the most significantly resembling sample document is assigned to the unclassified document. Sample documents may be acquired to build and maintain a repository of sample documents by detecting unclassified documents that are similar to other unclassified documents and subjecting at least some similar documents to a manual review and classification process. In a preferred embodiment the invention may be used to classify email messages in support of a message filtering or classification objective.

### BACKGROUND OF INVENTION

1. Field of the Invention

This invention generally relates to electronic document similarity detection and specifically to methods for recognizing duplicate or near duplicate documents transmitted by electronic messaging systems.

2. Description of Related Art

The need to control the escalation of unwanted commercial email message traffic and related “junk” communications provides a strong incentive to investigate document pattern matching technologies in order to improve upon existing solutions. As electronic mail and other messaging services have grown in availability and popularity, the phenomenon of junk electronic messages, also known as spam, has become a problem for providers of messaging services and their end users. Junk electronic messages are unsolicited messages distributed automatically to a large list of recipients on a network, such as the Internet, and may be sent by email, wireless text messaging services, instant messaging services or other electronic media. We use the term email synonymously with these other media as a convenience. A spammer is an individual or organization that creates and sends unsolicited electronic email via automation. Spam email messages typically consist of a broadcast of substantially the same message to hundreds, thousands or even millions of recipients within a short period of time. By definition, spam messages are of little or no interest to most recipients.

Why Spam is a Problem

Spam causes aggravation among recipients who receive unwanted email messages for a variety of reasons: If received in sufficient quantities by individual users, spam can hinder recipients from recognizing desired messages, sometimes causing desired messages to be inadvertently deleted due to the intermixing of spam messages (which users prefer to quickly delete) with desired mail.

Spam can create potential security hazards for email users, as many computer viruses and worms are distributed through email messages disguised as unsolicited commercial messages.

The increasingly common practice of including HTML-formatted material in spam messages, including graphics, increases the amount of data in such messages. As a result, spam messages take excessive time to download and display more slowly than text-only messages, increasing the time required of end users view, sort and discard unwanted email messages.

Spam wastes the network resources of Internet Service Providers (ISPs), corporations and Internet portals. The additional traffic burden that spam imposes on these organizations degrades network performance and increases their operating costs of providing email services. Spam adds to personnel costs by forcing system administrators to respond to complaints from end users and tracking down spam sources in order to stop spam. Further, ISPs object to spam because it reduces their customers' satisfaction with ISP services.

Spam sometimes exposes end users to content they may consider to be offensive, such as pornographic images embedded in email messages that use HTML formatting to display text and graphics in a message.

Corporations object to spam because it interferes with worker productivity and messages deemed offensive by employees (such as pornographic content) can contribute to a hostile work environment.

Why Spam Email Exists

The reasons these spam problems exist are several. First, electronic mail is easy and inexpensive to send in large quantities. Second, email addresses can be compiled quite easily for spam broadcasting purposes. Marketers and bulk email software providers cooperate with each other in the building and sharing of massive email address lists that are created through a variety of address harvesting techniques without regard to the preferences of the owners of these email addresses. Third, spammers are able to profit from a relatively small number of responses to their message broadcasts because the distribution costs of even large message broadcasts are so small. The senders of spam do not bear the social costs of their message broadcasts, in terms of the use of scarce network bandwidth and storage, and also do not bear the nuisance costs they impose on recipients who would rather avoid spam messages. The low incremental costs of sending email messages enable spammers to indiscriminately broadcast messages to every address they can acquire rather than spending resources to selectively identify interested prospects, in essence shifting the burden of discrimination from the message senders to receivers.

As a result of the absence of significant cost restraints on spamming and the low response threshold for attaining profitable results, companies and individuals engaged in this practice continue sending spam to unwilling recipients. In fact spam activity is on the rise as spammers seek to reach broader groups of recipients, even if this practice annoys large numbers of email users. Spam has begun to appear as a problem in other text messaging environments, including wireless text messaging (SMS) and instant messaging services.

Legal Remedies

In recent years there have been attempts to control spam by legislative means. Laws are unlikely to have much effect on spam activity because it is easy for spammers to access servers virtually anywhere in the world in order to send messages to anywhere else in the world. Federal or state laws and enforcement activities would therefore be faced with the difficulties of international enforcement efforts through cooperation with governments around the world.

Prior Art Spam Filtering Methods—Introduction

Prior art spam filtering systems control message delivery based on who appears to be sending messages, how messages are delivered and by analyzing attributes of message contents. In general, the problems with these methods have been that spam senders have learned to evade them by disguising their “sender” identities, delivering messages in a manner that does not signify a spam broadcast, and disguising the content of the message.

This section reviews the concepts and drawbacks of the prior art related directly to spam filtering and also reviews more generalized document classification techniques that are oriented to solving similar document analysis and classification problems. A key theme of this review is filtering accuracy. The ability of a document classification system to accurately determine the classification of an unknown document, such as an email message, can be measured by the relative quantity of errors it makes. Errors are classified as false negatives, or failing to recognize a match to a given pattern, and false positives, or incorrectly concluding that a pattern match exists when in fact it does not exist. A spam filter that incorrectly classifies a non-spam message as spam is generally thought to have made a potentially serious error. Many email users have little or no tolerance for false positive filtering errors.

Prior Art Spam Control Methods Involving Spam Sender's Cooperation

A number of proposals have been suggested for controlling spam by engaging (voluntarily or involuntarily) the cooperation of spam senders, including 1) conveying a recipient's lack of interest in receiving spam to a spammer, 2) charging spammers a fee to deliver messages to their intended recipients, 3) voluntary self-labeling of bulk email message content to aid in categorization and filtering, 4) registering bulk email sender identities, and 5) requiring a valid response to an automated challenge from a recipient's email system that are easy for non-spammers to overcome but that slow or disable automated bulk email systems' ability to deliver messages to protected recipients.

Conveying to a Spammer a Recipient's Lack of Interest in Receiving Spam

In U.S. Pat. No. 6,167,434 issued to Pang (2000) a system is proposed which automatically sends a request to a bulk email sender to cease sending bulk email messages to the recipient. The disadvantages of this method are that most spam messages do not include valid reply email addresses, and secondly, when they do provide valid reply addresses, requests to be removed from a list are seldom honored. Even when self-removal requests are honored, such mechanisms are not standardized and impose an annoying burden of time and effort on message recipients to request removal. Self-removal from spam distribution lists is therefore not a viable solution.

Charging Spammers a Fee to Accept Delivery of Messages

In U.S. Pat. No. 6,192,114 issued to Council (2001) another anti-spam method is proposed based on obtaining the cooperation of email message senders. Council teaches a method for billing a fee to a sender initiating an electronic mail communication when the sender is not on an authorization list associated with the intended message recipient. The disadvantage of this suggestion is that, if widely adopted, it would unnecessarily inhibit sending and receiving of legitimate commercial and non-commercial email by reducing its cost advantage over other forms of communication.

Voluntary Self-Labeling of Bulk Email Message Content

Various methods for reducing junk email have been proposed that include voluntary sender cooperation. Such suggestions as found in U.S. Pat. No 5,619,648 issued to Canale, et al (1997) put the burden upon the sender to specify more limited classes of recipients than simply defined by an email address list. In particular a technique is described which permits a sender to add structured information to the message header and discloses that a filter at the location of the recipient may use the information to automatically accept or reject messages based on a profile of the user that the user has permitted to reside within the filter. Similarly it is disclosed in U.S. Pat. No. 6,047,310 issued to Kamakura, et al (2000) that senders would register their email advertisements, providing a description of their attributes so that advertisements sent by email can be distributed through the use of automated distribution rules that will restrict message delivery based on receiver attributes similarly registered with a central computer. The flaws of these methods are that senders are not motivated to add the necessary descriptive information to enable improved filtering by recipients since the senders bear no additional costs of reaching non-interested parties.

Registering Bulk Email Sender Identities

A similar disadvantage would exist with an email header-based password scheme as proposed in U.S. Pat. No. 6,266,692 issued to Greenstein (2001) and for a system of requiring senders to register their addresses with a registration server prior to acceptance of their messages by participating recipients, as suggested in U.S. Pat. No. 6,112,227 issued to Heiner (2000). A commercial service known as Habeas provides bulk email senders with copyrighted content that they may include in the header sections of their emails as long as certain rules of bulk email practice are observed. Habeas promises to take legal action against violators of this voluntary program of promoting trust between participating senders and targeted message recipients. The disadvantage of this approach is that unless it is voluntarily adopted by most senders of bulk email, the program will provide only limited protection. Another drawback is that all messages from particular senders may not be classified by all recipients as being equally desired or unwanted. Spam designations are more closely related to content than to senders of messages.

Prior Art Spam Control Methods Not Involving Spam Sender's Cooperation

Senders of spam profit by sending high volumes of messages delivered so that even if only a small minority of interested recipients responds the spammer can earn a profit. Since it is very inexpensive to send email messages in large volumes, these profits are not affected by the fact that most recipients dislike receiving spam messages. Therefore it is unlikely that spammers will voluntarily restrain their activities. Most anti-spam solutions in use today recognize this problem and do not rely on voluntary cooperation of bulk mail senders. Instead today's spam filters attempt to identify spam messages based on the inherent characteristics of messages received. One simple characteristic to evaluate is whether the sender is known and approved by a recipient, which serves as a basis for the first prior art spam filtering method to be reviewed, whitelist systems.

Sender Whitelists

In U.S. Pat. No. 6,249,805 issued to Fleming, III (2001) it is suggested that unwanted bulk email can be eliminated by rejecting mail from any address that has not previously been included in a local inclusion list of authorized senders. The disadvantage of this method is that properly maintaining such a whitelist is too labor-intensive given the number of possible desired correspondents to whitelist. If the inclusion list is not updated regularly and does not reflect dynamic sender addresses associated with favored mailing list servers, an individual's whitelist will be inaccurate or will quickly become so, resulting in exclusion of desired e-mail messages from non-spam senders.

In U.S. Pat. No. 5,999,932 issued to Paul an automated system for maintaining a local inclusion list of authorized senders is disclosed. While this system reduces the labor involved in maintaining the inclusion list it cannot successfully allow mail from desired senders whom the user has not either manually or automatically authorized. Therefore this system will tend to produce false positive message classification errors.

Requiring a Valid Manual Response to an Automated Challenge from a Recipient's Email System

Challenge/response filtering systems attempt to improve upon whitelists by forcing each sender to undertake a verifiable action after attempting to deliver a message, thereby proving that the sender is probably not an automated bulk email system and instead is a living person. U.S. Pat. No. 6,195,698 issued to Lillibridge, et al (2001) discloses a system by which email message recipients can automatically issue a challenge question back to message senders and receive a reply before an email message from an unknown sender is allowed to be delivered. U.S. Pat. No. 6,199,102 issued to Cobb (2001) indicates that a similar type of challenge question must be accompanied by a method for determining whether a response is correct. U.S. Pat. No. 6,112,227 issued to Heiner (2000) teaches a similar system in which senders unknown to a recipient must properly register their identities with an intended recipient after sending a message but before delivery will be completed.

The basis of these suggestions is that imposing a small additional burden on legitimate senders using non-automated message delivery systems is an acceptable tradeoff to reduce or eliminate spam. Spammers are unlikely to take the trouble to respond to auto-generated challenge questions issued by recipients on their typically large email lists. As a result, it is expected that users of such systems are likely to receive little or no spam messages since their email addresses would become insulated from unknown senders.

One disadvantage of this system it that the burden of answering challenge questions is likely to be rejected by at least some desired senders who have not been pre-authorized by recipients, and mail from these desired senders also will be blocked, creating, in effect, a false positive error.

Another disadvantage of challenge/response systems is that they increase the number of email messages that must be sent from one to three in order for messages from unknown senders to be approved, increasing overall message traffic and introducing potential delays in delivery of time-sensitive messages.

Another disadvantage is that if mail recipients become accustomed to receiving challenges of this type from other mail recipients who have adopted a challenge response system, it would be easy for spammers to exploit this behavior by sending messages that mimic the appearance of challenge messages but are really links to spam senders' web sites in disguise.

Another disadvantage is that if challenge messages are sent to mailing list servers that are configured to forward list member replies to all list members, which is common, list members could become bombarded with copies of many such challenge messages.

Another disadvantage of the challenge/response method is that legitimate email list operators who send messages such as newsletters, account statements and other service announcements are not prepared to respond to challenge messages so recipients would not receive the legitimate automated messages. Whitelisting the addresses of such senders would be only partially effective because many large email list operators employ pools of servers to send messages, or employ third party emailing services, each of which may use a different sender address, making it difficult for an end user to effectively whitelist a legitimate bulk mail sender.

Replying to Messages with a Problem-Solving Challenge

Another form of challenge/response system is to require that the email system of an unknown sender of a message automatically respond to a challenge in the form of a mathematical problem to solve. The problem may be made arbitrarily difficult so that solving it becomes a burden to senders of large numbers of messages to a protected recipient domain, such as a business or ISP. Single messages to be delivered would experience a short delay in delivery, but senders of thousands or millions of messages would be severely inconvenienced. A sufficiently difficult problem would require enough computational cycles of the sender's system that it would become prohibitive to send a large number of messages, each message requiring a different problem to be solved, before messages can be delivered. As with other forms of automated challenges, this type of system can interfere with time-sensitive communications and can interfere with legitimate messages sent via automated list servers.

Sender Blacklists

There have been prior art attempts to eliminate unwanted bulk e-mail by blocking mail received from known bulk email senders. Centralized blacklists enable email system administrators to share their observations of spam broadcasters. With blacklists, spam is defined as any email message that appears to originate from a source known to have sent spam in the past. In U.S. Pat. No. 6,249,805 it is proposed that spam sources be identified on the basis of the message sender's email address, although identifying spam senders by the identity of the computer (IP address) that carried the message also is commonly practiced. The blacklist operator evaluates suspicious messages and, if they decide the messages are spam, they add the senders' IP addresses, domains, and/or email addresses to their blacklist of spammer ID information. Blacklist services update and publish their lists for use by email service providers for filtering mail received by their individual networks. Examples of popular public blacklists have included the MAPS Dialup User List and the Real Time Black Hole List (RBL).

One disadvantage of blacklists is that spammers frequently succeed in evading the blacklist filter. Spammers can forge their addresses so that blacklists are rendered ineffective. Spammers also can send mail from temporary email addresses that are set up to be used only once, to send out a spam broadcast. By the time a spammer's IP address has been reported and published to email administrators, the spammer will likely have moved on to a new address. Additionally, creating and maintaining these blacklists is very labor intensive for email administrators, who must perform manual steps to identify and report spam broadcasts. Another disadvantage of blacklists is that blacklisted domains sometimes are not used exclusively by spammers, but also are used by innocent, non-spam message senders. For example, when an ISP's domain is blacklisted because a rogue subscriber has engaged in spamming, many innocent subscribers of the same ISP may find that their outgoing messages also are blocked. The result is false positive filtering errors wherever a blacklist is in use that includes the domains of the innocent message senders.

In U.S. Pat. No. 6,321,267 a method is proposed to overcome the above disadvantage of blacklists by automatically updating the blacklist in real time whenever an email delivery attempt is detected. In one embodiment of this method, a check is performed automatically for an open relay or a possibly forged sender address whenever a protected email server receives an attempted mail delivery, making such determinations on a real-time basis. A weakness of this suggestion is that not all spammers use open relays or forge their sender addresses, making this system error-prone whenever these conditions are not present.

Filtering Email Based on Message Delivery Attributes

Another approach to spam filtering is to employ filtering rules that are triggered whenever certain aspects of message delivery are present. These tests do not directly attempt to identify a particular sender or particular message content but look for circumstantial evidence that a message may be part of a spam broadcast. While many possible tests can be performed in this vein, a few common examples are as follows:

Detecting non-conforming message header information formats, or those that do not comply with accepted email standards;

Detecting spam-like sender address content patterns, such as sender addresses that contain unusual combinations of numbers and letters (such as gina4992109848@hotmail.com);

Detecting spam-like recipient address content patterns, such as a recipient address that appears the same as a sender address, or a recipient address list that includes many addresses for a single message;

Detecting messages that appear to have invalid dates, such as 12 hours ahead of the current time at the mail receiving location;

Detecting messages that have suspicious attached files sometimes associated with viruses, such as executable files with a file name extention of “.exe”;

Detecting messages that have suspicious subject line patterns, such as a series of numbers, as in the case of a subject line like “Limited Time Offer 4098309489”

Performing a reverse Domain Name Server (DNS) lookup to determine whether the sending mail server identifies itself with a valid server address; if not, then the message it is sending could be considered spam as many spammers exploit poorly configured email servers to send their messages. In U.S. Pat. No. 6,393,465 issued to Leeds (2002) a method is disclosed for contacting a purported sender in order to verify that the identified host computer actually exists and accepts outgoing mail services for the specified user. The routing history is also examined to ensure that identified intermediate sites are also valid. The disadvantage of this method is that any spam messages sent from a valid server address will not be detected.

The above techniques may be used individually or in combination. For example, in U.S. Pat. No. 6,321,267 issued to Donaldson (2001) a filtering proxy is described that actively probes remote email server hosts attempting to send messages and conducts several tests for spam sender attributes, including connect-time filtering based on IP address, identification of dialup PCs attempting to send mail, testing for permissive (open) relays, testing for validity of the sender's address, and message header filtering. A sender's message must successfully pass through all relevant layers, or it is rejected and logged. Subsequent filters feed IP addresses back to the IP filtering mechanism, so subsequent mail from the same host can be easily blocked.

The disadvantage of these techniques is that they can easily be evaded by spammers so that much spam will tend to slip through filters using these methods. Another disadvantage is that such methods can cause false positive errors whenever innocent messages are sent featuring any of these patterns thought to be indicative of spam. For example, the techniques of using reverse DNS lookups or checking for non-standard message headers tend to block non-spam messages that originate from innocently misconfigured mail servers.

Message Frequency Count

Another message delivery pattern that can serve as the basis for message filtering is providing a means of counting instances of the same message, or substantially the same message, that are received at different addresses within a short time period. When a count of messages that are the same or similar to each other reaches or exceeds a given threshold, messages that match or are substantially similar in terms of content can be classified as spam. With this approach, flows of multiple messages that are the same or are similar to each other trigger an alert or a filtering action. The disadvantage of this approach is that it may easily be circumvented by spammers by segmenting their message broadcasts into small blocks, sent at random intervals and using randomly sequenced connections across multiple ISPs. To the extent that this approach judges message similarity based on message content, as opposed to point of origin, it is fundamentally content based and is examined further below, but is mentioned here because it requires the ability to detect a delivery pattern at a network level in order to be implemented. If content based, this method requires a way to discern when messages are similar and not simply exact duplicates because much spam content is intentionally made variable in order to avoid simplistic fingerprint or signature based filtering.

Prior Art Spam Control Methods Involving Message Content Pattern Analysis

Besides detecting spam based on sender identities and delivery attributes, a third class of filtering is based on testing for the presence of matching content within the subject lines, message bodies or files attached to email messages. The underlying assumption with content-based document classification methods is that if an unknown document shares at least a portion of its content with that of a known and previously classified document, then the unknown document may be of the same classification as the known document.

The challenge for content-based document similarity detection methods is to correctly discern significant partial duplicates among documents without making false positive errors. In some document similarity detection applications, such as email classification or filtering, some documents may feature deliberately camouflaged document content that varies from one copy to another, making correct distinctions difficult. Although most documents, such as email messages, may follow predictable rules in terms of their use of language and document structure, some documents may be authored in a way that bends or breaks these rules in order to evade content-based document classification or filtering systems. It is relatively easy for the author of a spam message broadcast to write a program that will cause every message comprising a spam broadcast to vary in some way in order to make detection of partial message copies more difficult by fully automated systems.

It has been suggested that attempts to detect partially duplicated message broadcasts may be futile in the long run because spammers can so easily employ message content varying techniques as an effective countermeasure to fingerprint-based filtering. (See, for example, “A Countermeasure to Duplicate-Detecting Anti-Spam Techniques,” Robert J. Hall, AT&T Labs Research, 1999.) Spam email senders can subvert fully automatic content-based similarity detection systems using various spam message camouflage techniques to exploit the difference between human and machine cognitive abilities. These techniques include: a) heavily padding the payload or recurring portion of a spam message with dynamically altered and irrelevant text; b) using formatting characters to either hide text inserted for camouflage purposes or to dynamically alter the document as it appears to a software program while leaving it readable to a human; c) avoiding the use of natural words, such as by rendering words as pictures through the use of hypertext links to graphical image files, by replacing some letters with non-alpha characters that resemble letters, by using randomly mixed language character sets, by intentionally altering words spellings or by dynamically altering longer document portions such as sentences and paragraphs; d) using intentionally mal-formed language, such as misspelled words or similar obfuscating techniques to dynamically render content capable of being understood by a human reader but not by a software program;e) composing very short messages, such as message containing only a hypertext link and varying a portion of the link text for each message copy; and f) frequently altering the message payload so that a training set is constantly out of date.

Table 1, below, provides a more detailed list and examples of these and other techniques of email document obfuscation.

TABLE 1
Email Document Content Obfuscation Techniques and Examples

| Technique | Example |
|---|---|
| Padding message | p Kdbsl1br Jared Mckinnon hEmail Advertise to |
| payload content | 27.5 Million People - |
| with randomly | $129.00http://www.emailbroadcasting.org or |
| inserted and | http://202.63.201.2391 v Jared Mckinnon |
| irrelevant | Kdbsl1brvqspj ym xjf tl egwx jxkpwh |
| characters, words, | |
| phrases or | |
| paragraphs. | |
| Padding message | <a |
| payload content | href=“http://www.topvalues.com/1234.htm”>Click |
| with randomly | here</a> <br |
| inserted and | siois99g89324hn0ias9gfus9fdhg943hhfgiha> |
| irrelevant text | |
| contained in | |
| HTML formatting | |
| tags, metatags | |
| tags or non- | |
| standard tags | |
| Encoding | Base 64 encoded: Q2xpY2sgaGVyZQ==Non- |
| message content | encoded: Click here |
| in a form | |
| unreadable by an | |
| email filtering | |
| systems without a | |
| decoding | |
| mechanism but | |
| readable to an | |
| email reader | |
| Encoding URLs | http://www.angelfire.com%40%77w%77%2e%63 |
| using hex, | yb%65%72%67atew%61%79%2e%6e%65%74/ |
| decimal or octal | s%70%61%6d%6d%65r/%69%6Ed%65%78.%6 |
| encoding | 8%74m%6C#3491382728/%32c%72%65%64%6 |
| | 9%74c/%69%6Ed%65%78.%68%74m%6Cis an |
| | encoded form |
| | ofhttp://www.angelfire.com@www.cybergateway.net/ |
| | spam- |
| | mer/index.html#3491382728/2creditc/index.html |
| Padding URLs | This URL |
| with randomly | http://www.angelfire.com@www.cybergateway.net/ |
| inserted and non- | spam- |
| functional text | mer/in- |
| | dex.html#3491382728/2creditc/index.htmlfunctions |
| | in the same way as |
| | http://cybergateway.net/spammer/ |
| Splitting words, | Click here = Click <!--random word--> here |
| phrases or para- | |
| graphs using | |
| HTML comments | |
| padded with | |
| random content | |
| Splitting words | L-o-w---R-a-t-e---M-o-r-t-g-a-g-e |
| by inserting | |
| padding | |
| characters such as | |
| spaces or | |
| asterisks | |
| Padding text | Text MIME part in- |
| MIME part with | cludes:0934fdn0ifdig09emgf09i349hjfd |
| noise to | jfjg9e9g-j349fgHTML MIME part includes mes- |
| camouflage | sage payload content. |
| HTML mime part | |
| Embedding | JavaScript program code inserted between |
| message content | <Script> </Script> tags in an HTML document can |
| in an | be used to dynamically generate content when |
| automatically | HTML document is viewed by email reader. |
| executing | |
| program that | |
| alters message | |
| content upon | |
| viewing | |
| Substituting | “Click here” rendered as Click here” |
| characters with | |
| similar characters, | |
| such as foreign | |
| characters | |
| Rendering text in | <a |
| the form of a | href=“http://www.topdollars.com/webpage.html”> |
| hypertext-linked | <img |
| graphic image | src=“http://www.topdollars.com/images/12.gif> </ |
| file, minimizing | a> |
| the amount of | |
| content to be | |
| matched. Usually | |
| combined with | |
| URL obfuscation | |
| techniques. | |

A practical limitation on spam message senders is that it is usually costly to completely alter the portions of their messages that indicate how a recipient may inquire for further information or act on a solicitation. Internet domains, phone numbers and postal addresses serve as “call to action” text in broadcast email messages, and these elements are not easy or inexpensive to alter with great frequency. However, even if elaborate content-varying practices are not adopted by the majority of spammers, catching the last few percentage points of spam may require an effective way to identify highly camouflaged spam content in which most of the content is variable.

Therefore, in an environment in which some document authors actively seek to subvert a document classification system using dynamically varied document copies, it is not only necessary to detect partially matching document content, it is also necessary to determine which partially matching content is semantically significant considering the intentions of the message sender. While the significant content may be easy for a human reader to detect (and usually this must be the case in order for a duplicated document, such as a spam message, to serve its sender's purpose) the pattern may be difficult for an automated system to detect.

Prior art methods of detecting similar documents, such as email documents, generally are unable to make consistently accurate content distinctions when active and subtle measures are taken by document authors to evade detection. The success of evasion tactics relies on the significant gap between human and machine pattern recognition ability. The discussion now will turn to prior art methods of email document similarity detection or filtering systems and will later evaluate more generalized document similarity detection or classification systems.

Attachment-Based Filtering

One technique used to filter email messages that may be spam or computer virus carriers is to analyze messages that include attached files, such as image files, other multimedia files or executable program files. The disadvantage of this approach is that most spam messages do not feature file attachments, while some non-spam email messages do include attachments. This method is therefore a coarse filtering technique that could cause a high incidence of both false positive and false negative errors.

Message Subject and Message Body Content Filtering

Other than message headers and attached files, the heart of a message is its body, although subject lines contained in message headers also are often considered a form of message content. Content filtering includes relatively simplistic keyword matching applications and more complex methods that attempt to detect multiple content attributes that are thought to be indicative of spam. Beyond the field of spam filtering, many systems have been suggested for different document classification applications that might provide guidance for improved spam detection approaches. These applications include detection of plagiarism or copyright violations, compacting duplicate search engine results and general methods of information retrieval. Some of the document similarity detection schemes devised for these other applications are examined as well. In each example of prior art, the following analysis framework is used in order to understand how the prior art compares to the present invention:

1) Is the document classification method based on a model of a document class or a set of individual cases (individual documents) exemplifying a class?

2) Does the method use information about a document other than its content to make a classification decision, such as information in an email header, identification of a sender, or an evaluation of a message delivery pattern?

3) How are document content features defined and compared between unclassified documents and the document pattern base?

4) Is human judgment employed to assist in interpretation and refinement of the pattern base, and if so, how?

5) How is the pattern base updated to reflect new patterns?

6) Is the classification method capable of supporting only yes/no decisions or are multiple classes supported?

Keyword/Keyphrase Filtering

U.S. Pat. No. 5,377,354 issued to Scannell et al (1994) describes a method of prioritizing electronic mail based, in part, on keywords chosen by the user which, when found in the body of a piece of electronic mail, provides the basis for email sorting and prioritization.

U.S. Pat. No. 6,023,723 issued to McCormick, et al (2000) and continued by U.S. Pat. No. 6,421,709 issued to McCormick, et al (2000) discloses a similar method for filtering unwanted junk email that uses, in part, a set of keywords as a method of defining messages to be excluded from the mail flow. In U.S. Pat. No. 6,173,298 issued to Smadja (2001) a method is disclosed for automatically updating a dictionary of bi-grams, or word pairs, which may be used to detect matching bi-grams in unknown documents for classification purposes. In U.S. Pat. No. 4,823,306, entitled “Text Search System” and issued to Barbic, et al (1989) a method is described that generates synonyms of keywords. Different values are then assigned to each synonym in order to guide the search.

Unlike the present invention, the keyword filtering method represents a model of a class of messages to be filtered, rather than a set of cases. Document content features are represented by words or phrases, typically comprising a relatively sparse subset of overall document content, such as a few substrings. The disadvantage of this approach is that too little information may be present in the keyword or keyphrase to make an accurate determination about other messages because other information in the messages that might affect a classification decision is ignored.

Matching against keywords can lead to false negative errors as spam message senders learn which keywords should be avoided or if they are willing to use unusual spellings that do not follow normal language patterns (such as substituting the string “CA$H” for the string “CASH”). False positive errors can arise whenever non-spam messages contain strings identified in a keyword-filtering list as indicative of spam.

While human judgment may be employed to select and implement keyword-filtering rules, the process is tedious and reactive, often requiring substantial time in order to maintain keyword-filtering rules in the face of a large and increasing volume of unwanted messages. Keyword filters typically are updated by manually reviewing messages that escape the filtering process, involving reports from end users in order to learn which messages must be reviewed to discover new keywords that must be added to a filtering list.

Besides the labor required to update rules, another disadvantage of keyword and phrase-based filtering is that any delays in implementation reduce filtering effectiveness. Minutes and seconds sometimes count when spam broadcasts are in progress. If it takes several minutes or hours before new spam samples are found and new rules are written and tested, then a spam broadcast may have completed its cycle and the new rule will be implemented too late to provide any benefit.

An additional disadvantage of keyword filtering is that it generally cannot distinguish the true topic of a message because so little information is considered in each evaluation. As a result, keyword filtering is used only to estimate whether a message is spam or not, and not to support customized filtering by topic according to the preferences of individual users.

Probabilistic Document Comparison Approaches

The prior art in email message filtering and in the broader document classification field includes references to a variety of statistical modeling techniques for document classification. This approach attempts to overcome simple keyword string matching strategies by intelligently assigning probabilistic weights to multiple content features of unknown documents based on their collective frequency of occurrence in training set documents of a known classification. Unlike the present invention, this approach is based on a model of a class, rather than a set of examples of a class. Each of the probabilistic techniques suggests comparing identifiable text features extracted from documents, such as email messages, to similarly identifiable text features extracted from a training set of documents, such as spam and non-spam email messages. An evaluation is then made to determine whether the relative frequency of occurrence of text features within an unknown document corresponding to features of training set documents is high enough to conclude that the unknown document matches the class of training documents.

U.S. Pat. No. 6,199,103 issued to Sakaguchi, et al (2001) teaches a method for analyzing examples of junk mail, extracting a list of keyword pairs and statistically estimating keyword significance according to the frequencies of occurrence of extracted word pairs.

In U.S. Pat. No. 6,161,130 issued to Horvitz, et al (2000) a similar method uses automatic extraction of keywords and phrases and other partial features (such as formatting attributes) of message text found in sample spam messages and classifies message content according to a probabilistic feature distribution model derived from a training set of known messages.

In U.S. Pat. No. 6,192,360 issued to Dumais, et al (2001) a method is disclosed for generating, from a training set of textual information objects, each either belonging to a category or not, parameters of a classifier for determining whether or not a textual information object belongs to the category.

In U.S. Pat. No. 6,314,421 issued to Sharnoff, et al (2001) a method of indexing documents for message filtering is disclosed that compares a randomly selected sample of n-word sequences extracted from a message to sequences in a database of sample documents to determine whether a significant match exists.

In U.S. Pat. No. 6,094,653 issued to Lie, et al (2000) a document classification method is disclosed in which word clusters extracted from unclassified documents may be compared to word clusters extracted from previously classified documents. Unknown documents are classified according the estimated probability of occurrence of word clusters in an unclassified document based on their observed frequency of occurrence within previously classified documents.

In U.S. Pat. No. 6,556,987 issued to Brown, et al (2003) a text classification system is described which extracts words and word sequences from a text or texts to be analyzed. The extracted words and word sequences are compared with training data comprising words and word sequences together with a measure of probability with respect to the plurality of qualities. Each of the plurality of qualities may be represented by an axis whose two end points correspond to mutually exclusive characteristics. Based on the comparison, the texts to be analyzed are then classified in terms of the plurality of qualities.

Disadvantages of Probabilistic Feature Comparison Approach

One disadvantage of statistically based document classifiers is that erroneous classifications can occur due to loss of document feature detail. Aggregation of document training set features into a composite model defining a genre of a document classification, as opposed to a set of distinct cases or examples of a document classification, merges observations into a generalized representation of content representing a class, such as either spam messages or non-spam messages. Document classifications using a model of a class, rather than individually employing each of a set of examples of a class, thus leads to relatively indistinct boundaries on errors.

Because probabilistic methods simply identify statistical correlations, the causes of errors can be difficult to evaluate, requiring an analysis not of a specific match but of a whole set of cases comprising a pattern base. When classification errors occur, the reasons may not be readily apparent because no single sample document is responsible for a classification. This fact makes explaining errors to users difficult. Retraining the model to correct a significant error may not be as simple as adding one additional sample to the training set because the weight of other similar documents that are classified incorrectly may have to be overcome.

Another disadvantage of statistically-based spam filters is that spam email senders can subvert the document feature frequency distribution measurement process using various spam message camouflage techniques to exploit the difference between human and machine cognitive abilities, as discussed above.

By using document obfuscation techniques such as these, spammers can undermine a fundamental assumption underlying the probabilistic document classification approach—randomness. Probability theory is not applicable to spam filtering if variations in document features are not random. Probability theory is based on the assumption that phenomena being measured are characterized by uncertain outcomes that follow a random distribution pattern such as a normal distribution curve. The fact that spam email senders actively attempt to thwart filters, including filters based on statistical models, suggests that statistically based filtering models will cause errors that are not randomly distributed. Spammer determination to cause false negative filtering errors can be expected to tilt the distribution of observed document features in an apparently random fashion, when in reality a distinct pattern is present (the spam message payloads) that, by spammer design, can still be easily discerned by spam message recipients. The fundamental problem is that the relatively weak cognitive powers embedded within a statistical model of the genre of spam messages can easily be outwitted by the human intelligence of spammers. Spammers can use obfuscation tactics as described above to undermine the assumption of document feature randomness, leading to false negative filtering errors.

Another disadvantage is that false positive filtering errors can occur if a non-spam message is encountered that contains features statistically associated with spam messages. The likelihood of such an occurrence increases as spammers adapt to filters by composing spam messages to appear similar to non-spam messages. As these camouflaged spam messages are entered into the spam sample training set during updates, the features of the spam message training set will become less distinct from the features of the non-spam sample training set, leading to higher false positive error rates.

While statistically based filters advantageously employ human judgment in selecting messages that comprise the training sets, a disadvantage of statistically based spam filters is that they don't scale across users. Instead such filters must be tuned to individual users' spam and non-spam message samples by identifying and reporting errors at the individual user level. This weakness places a burden on end users to customize filter operation, by selecting and classifying a significant number of messages of each type from their own email archives. While most users' spam may have similar characteristics, the legitimate mail is characteristically different for everybody. The characteristics of a training set of legitimate messages are usuallyjust as important for tuning the statistically based spam filtering process as the characteristics of a training set of spam samples. Training the filter can represent a significant adoption burden, and ongoing training is required of users whenever spam and non-spam message content patterns change.

Statistically-based filters could potentially support multiple classifications, but again, the problem is that end users must go to the additional trouble of classifying sample messages in order to train the filter, representing an even greater burden than simply training the filter to recognize spam vs. non-spam messages.

Fingerprinting, or Case-Based Approach

Fingerprinting Concept

Comparing email fingerprints to the fingerprints of a set of known spam messages can be used as a spam identification strategy. Unlike probabilistic approaches described above, fingerprinting is case-based, rather than model-based, in terms of its matching strategy. The model based approach compares features of an unclassified message to a set of known features extracted from a set of known messages. The features are merged into a composite representation, or model, of spam messages. Some weights may be attached to features, as described in the probabilistic models, above, but the model approach is distinctly different from the case-based approach. The case-based approach compares the features of an unclassified message to each distinct set of features comprising a set of sample messages that have previously been classified. The highest degree of similarity between the unclassified message and one of the sample messages then becomes the metric by which a classification decision for the unclassified message is made.

As the prior art has established, if a well-designed document fingerprinting algorithm is employed, such as a hashing algorithm, digital fingerprints can be used to reliably detect whether two different strings of a document exactly match or not. Fingerprints are compact fixed-length digests of text strings of any length and are extremely unlikely to be the same whenever they are derived from text strings that differ by at least one character. Fingerprints can be computed with great computational efficiency.

Fingerprinting offers the advantage of considering all the content of a document rather than a sparse subset of content, potentially placing tighter boundaries on errors. Therefore, unless messages are very short, a document fingerprint offers a much more detailed representation of a document. Fingerprinting therefore could be used to better discriminate between spam and non-spam messages.

Challenges to Identifying Spam via Fingerprinting

Attempts have been made to more precisely identify and filter out spam by computing a mathematical digest, signature, or fingerprint of the text comprising the bodies of email messages. Several practical problems arise when attempting to use a fingerprinting approach for spam filtering, including:

a) coping with spam content variability within similar message broadcasts,

b) building and maintaining a spam sample repository of sufficient scope and quality to enable identification of a satisfactory amount of spam, and

c) supporting selective filtering according to potentially different user definitions of spam.

Coping with Spam Content Variability

A single fingerprint of a spam message is unlikely to be effective in most cases because spam messages frequently contain personalizing or random document content in order to prevent them from being filtered by such a simple technique. The advent of simple fingerprint-based email filters, such as Vipul's Razor in its early form, has caused many spam email senders to adapt their strategies of filter avoidance to include the use of content camouflaging techniques that render simplistic exact matching techniques ineffective. As illustrated in Table 1 above, a variety of email message camouflage techniques can be used to subvert content-based pattern recognition methods, including methods using statistical profiling of word frequency distributions or using document fingerprinting. The use of these techniques to camouflage recurring document content requires adaptation of the fingerprinting strategy. Fingerprinting should be adapted so that it can detect partial matches that are significant without erring on the side incorrectly classifying non-spam messages as spam in order to minimize false negative errors.

A variety of methods have been proposed for adapting fingerprinting strategies so that they can identify partial matches, including the Distributed Checksum Clearinghouse and others discussed below. In general, a fuzzy matching approach using fingerprinting works as follows. Documents to be compared are broken into primitive units such as paragraphs, sentences, words or other character sequences. Various terms that refer to the process of decomposing a document into substrings for comparison include the terms “partitioning,” “sectioning,” “tokenizing” and “chunking” of text into units or substrings that are shorter in length than the original text. Rules are applied to this decomposition process so that substrings are extracted in a consistent way from both unclassified documents and previously classified documents. The resulting text units are then hashed and the hash values, or fingerprints, for unclassified documents are compared to those of previously classified documents. Whenever a predefined number of hash codes for a tested document match those for a known document, document similarity is said to exist.

A variety of implementation issues arise in attempting to adapt fingerprinting so that partial matches may be reliably detected. These include the selecting the chunking strategy, determining if some content should be stripped, determining whether entire chunks should be discarded, and selecting a method for determining similarity according to a pattern of matching chunks. Additional issues that affect practical usage include finding effective methods of sample collection and providing filter customization.

The chosen definition of a chunk is critical because it affects the computational costs and filtering accuracy. Interrelated chunk attributes include chunk boundary definitions, chunk size, including fixed or variable length, and chunk overlap, if any. One method of selecting document substrings or chunks is to extract all substrings of a fixed character length (n-grams) or a fixed number of words, sentences or paragraphs in length. The prior art suggests that accurately detecting sentences can be difficult. In some cases the substrings may be padded to make them all of equal length. These techniques may be configured to extract either overlapping or contiguous substrings. In other cases anchor points defining the beginnings of chunks may be selected based on words or other recognizable document features and chunks endpoints are determined by syntactic breakpoints, such as punctuation marks or other types of chunk boundary definitions.

Prior art teaches that some preprocessing of document contents may occur to make the substrings more suitable for fingerprint comparison. Preprocessing may include removal of some document content that is considered insignificant for matching purposes or that may hinder similarity detection, such as common words, punctuation, spaces, personalization content or hidden content added to confuse filters. Letter case may be altered to a common format, such as lower case.

The prior art also teaches that preprocessing may be extended to chunks themselves, so that removal of some chunks improves the fingerprinting by either reducing large chunk sets to smaller, more manageable sets, or removing very common chunks that add little to the document classification outcome. The chunk removal question represents a tradeoff between losing potentially valuable information versus achieving computational efficiency and scalability. In applications involving large and numerous documents, such as indexing Web pages on the Internet, a choice is usually made to use a sparse subset of document chunks. While loss of detail in such applications may lead to some errors, generally these errors, including false positive errors, are considered tolerable in exchange for the large increase in efficiency that may be obtained by culling the set of chunks to be compared.

Prior art teaches various methods of determining whether a collection of document chunks or substrings is sufficiently similar to those of a previously classified document to conclude that a significant similarity exists, enabling a document classification decision to be made. These methods include computing a ratio of overlapping or identical chunks and computing a statistical correlation value.

Building and Maintaining a Spam Sample Repository

In order for a fingerprinting strategy to succeed, a repository of documents representative of a class, such as a repository of spam messages, must be collected and maintained. Ideally the repository is both sufficiently comprehensive that it can be an effective spam identification pattern guide and also excludes non-spam patterns that might be mistakenly or maliciously submitted for inclusion and that could lead to false positive errors. The prior art teaches a variety of centralized and distributed techniques for building and maintaining such a sample message repository.

In one model, spam message samples are collected from human observers, typically either email system administrators or end users, who identify spam messages that have penetrated a filter. The disadvantages of this method include the burden placed on end users to serve as human filters, the time lags resulting from manual identification and reporting of suspected spam messages, and the potential for such a system to be abused if not moderated by a trusted administrator or other means to ensure the correct classifications of submitted samples.

In another prior art method, as described in U.S. Pat. No. 6,052,709 issued to Paul (2000), a network of decoy email addresses is established that are intended to attract and forward spam messages to a central spam filtering authority by convincing spammers that the addresses are valid user addresses. One disadvantage of this method is that decoy email addresses may not be distributed with sufficient breadth across the many domains that comprise the Internet to attract a sufficiently comprehensive and current sampling of spam messages.

Supporting Customized Filtering

Most prior art in spam filtering teaches methods that treat spam email message filtering as a binary classification problem—either a message is or is not spam. Some prior art mentions that messages should be quarantined for human review whenever it cannot be determined whether they are spam or not. In reality, many email users have differing opinions as to what types of bulk email content constitute unwanted messages, so “spam” is a relative definition. In a content-based filtering model, it would be possible to classify message content according to user-defined topical categories in order to support customized filtering, a feature that is absent in the prior art. None of the systems described above permit a reliable determination of a document's topic based on its similarity to another document. Topic-based filtering would not be reliable using the prior art methods of determining resemblance of unclassified messages relative to a pattern base because messages of different topics may contain enough shared content to result in a misclassification, while messages of the same topic may contain enough obfuscation content to prevent accurate identification of a significant content (and topic) match.

Prior Art in Email Fingerprinting

Prior art in email fingerprinting for spam detection purposes includes Vipul's Razor, which began as a peer-to-peer exchange of hash codes representing the bodies of email messages determined to be spam by participating email administrators. The system, which has since evolved into one using statistical signatures, originally used an exact message body matching strategy. As spam senders adapted the exact matching strategy increasingly failed to catch spam messages containing dynamically varied content. The spam pattern database relied upon reports of spam messages by participating email administrators. No mechanism existed to assure that sample messages actually met an agreed-upon definition of spam. The system provided no support for custom filtering, returning only the outcome of check for an exact message body match.

In U.S. Pat. No. 6,330,590 issued to Cotten (2001) a fingerprint-based system for preventing delivery of unwanted email is described. One improvement with this system over the exact message body matching strategy is that, prior to fingerprinting, messages within the reference set (i.e., spam messages) and incoming email messages both are stripped of certain content that would vary within otherwise matching messages, including addressing information and other personalizing text. A check is then performed to determine whether an exact match on the residual text of an incoming message exists in comparison to a message in a spam database. As a further check, a set of at least two identical messages addressed to different email addresses must be detected to make a spam determination, based on the assumption that spam messages are routinely sent to multiple recipients.

One disadvantage with this method is that many near-duplicates will be missed. Errors will result because the types of dynamic variation in message body content extend far beyond personalizing elements and include variations in line and word spacing, noise characters, words, phrases or paragraphs intentionally inserted to partially randomized message content, variations in URLs, file attachments and other small but significant potential differences.

Another disadvantage is that employing a message frequency counter to assess whether a message is spam causes a delay in detection if spammers rotate delivery across multiple domains during broadcasts in order to evade frequency count detection schemes.

A third disadvantage of Cotten's method is that it relies on the enlistment of email recipients to actively attempt to attract bulk email messages so new spam messages may be reported to a central authority and added to a database. This method places a burden on end users of reporting new spam sightings and creates a possibility of accidental or deliberate incorrect reporting of spam samples because no provision for moderating or checking submissions is provided.

A fourth disadvantage is that Cotten's method is not capable of supporting classifications other than yes/no spam classification decisions.

The Distributed Checksum Clearinghouse (DCC) is a cooperative, distributed system intended to detect “bulk” mail or mail sent to many people. It allows individuals receiving a single mail message to determine that many other people have been sent essentially identical copies of the message and so reject the message.

One disadvantage of this approach is that, strictly speaking, it only detects bulk email messages, not spam messages specifically, which may be considered a subset of bulk email. Since there is no central authority moderating the classification of messages reported, differences of opinion as to which messages are spam may arise and some bulk email messages that are not considered spam may be blocked.

In U.S. Pat. No. 6,421,709 issued to McCormick (2002) a similar signature-based approach is employed to detect spam messages, including a hash value based on the email message's body content.

The matching function is said to use a combination of techniques (e.g., checksum, fuzzy matching) to generate a likelihood that two messages are essentially equivalent but no specific information is provided about its implementation. McCormick also suggests using a message frequency counter, which has the disadvantages cited above in Cotten.

Human judgment is not employed in McCormick's method to assist in interpretation and refinement of the pattern base other than to accept spam samples from end users, which also has the disadvantages mentioned with Cotten's use of the same technique. McCormick's technique is not capable of supporting classification decisions other than spam or not spam.

In U.S. Pat. No. 6,460,050 issued to Pace (2002), a fingerprinting-based method of spam identification is suggested that seeks to detect partial message matches by hashing multiple portions of the content under investigation. This approach advantageously considers components of a message, rather than simply hashing the entire message or the residual message content after some simple content stripping. However Pace suggests using information within messages that is easily obfuscated, such as the message subject line, leading to potential classification errors. The more serious drawback of Pace's method is that it places heavy reliance on a content frequency algorithm to measure message similarity, including counts of particular words or letters, or, for example, the relationship of the most common words in a message to the second most common words in a message. The disadvantage of this approach is that it is subject to evasion whenever spam messages contain content or structure designed to subvert feature frequency comparisons. As with Cotten and others, Pace relies on a collaborative spam reporting system in which end users are enlisted to keep the spam database current, which entails the disadvantages associated with this method as noted above. Human judgment is not employed to assist in interpretation and refinement of the pattern base, and the classification method is incapable of supporting anything other than yes or no decisions.

In U.S. Pat. No. 6,453,327 issued to Nielsen (2002) a junk email identification scheme is disclosed which incorporates various spam detection methods, including a fingerprint-like method. The system also relies heavily on a collaborative effort by end users to identify and share observations of new spam message sightings in order to update the filtering mechanism, and implements techniques for authenticating the identities of participating end users as members of a trusted group of collaborative spam reporters.

Effective email filtering based on samples reported by a subset of an email user population is only possible if significant partial similarities between junk email messages, or messages of the same classification of any kind, can be reliably detected. A drawback of Nielsen's approach is that it contains similarity detection methods that will cause it to fail in filtering messages that are spam but contain enough obfuscating content to camouflage their resemblance to previously reported spam messages. The method by which copies of messages classified as junk consists of a check of the message ID number, which is easily forged or varied by spammers, and failing that, a second test of a combination of several message elements, including the sender ID and subject line and the first five lines of body content. No preprocessing of message body content or decomposition into smaller content chunks is undertaken, so simple obfuscation tricks will cause this method to produce false negative errors on at least some occasions. Further, human judgment is not employed to assist in interpretation and refinement of the pattern base.

Nielsen's method employs a decentralized spam sample reporting system comprised of a group of trusted end users that are the intended message recipients. These users observe spam messages that evade filtering and report them to a central authority so that the filtering system may be updated for the benefit of other users who also may be targeted to receive the same spam messages in the future. As with other prior art this method of updating the pattern base places a burden on end users to supplement the spam filter with their own efforts while being susceptible to delays in reporting and incorrect reporting.

Nielsen's method uses a spam report frequency counter seeks to weight any evidence of “junk” message status by gaining some consensus from multiple trusted users. However, some unwanted messages may only be observed once or rarely in a particular domain, even though they may be part of a large broadcast affecting many users outside the sphere of protected users. Therefore a further drawback is that requiring a minimum number of users to report a copy of the same spam message adds to the potential delays in updating a spam pattern base.

Another drawback of Nielsen's spam pattern update method is the cumbersome steps suggested for preventing rogue users from incorrectly reporting non-spam messages as junk when they are not junk, thereby interfering with delivery of desired messages to other users. Nielsen proposes that users be authenticated via a digital certificate system to ensure that they are trustworthy. This is not user friendly because it requires installing software and adding a layer of security to the email system. Further, even a group of trustworthy users may disagree in some cases about whether a particular message copy or near copy is spam or not. Therefore another drawback to Nielsen's method is that it does not provide support for topical-based filtering but instead is limited to yes and no spam classification decisions.

Other Prior Art in Document Fingerprinting

The prior art in document similarity detection provides many examples of document fingerprinting comparison techniques have been developed for other applications but do not adequately address the problem of detecting spam messages. In general, these prior art methods cannot cope well with fingerprinting countermeasures used by some spam message authors. These countermeasures camouflage email messages with obfuscating content that varies across functionally similar messages, and may also be written in ways that make them difficult to automatically distinguish from non-spam messages. Prior art document fingerprinting methods are not coupled with any system for incorporating human judgment into the pattern base in order to intelligently identify and compensate for obfuscation content. Instead the prior art relies entirely on automated methods of similarity detection. Thus, as with the spam-filtering prior art, the more generalized document fingerprinting methods can be fooled by active fingerprinting-avoidance countermeasures.

Additionally, most of the prior art dealing with document fingerprinting teaches that document contents are to be broken into relatively small chunks for fingerprinting purposes, such as short fixed- or variable-length character sequences, words, or short word sequences of two or three words. Whether the document chunks are based on character sequences, words, short word sequences, overlapping or not overlapping, the small-chunk approach leads to high computational and data storage costs. Using a chunking strategy based on relatively small content chunks also leads to higher error rates. Small chunks cause the detection process to be more sensitive to small content differences between similar documents, leading to false negative errors, while also increasing the chances that shared content of functionally dissimilar documents will produce matches, leading to false positive errors.

The prior art teaches that use of randomly sampled subsets of small document chunks can be used to reduce the computation and storage costs. This approach can lead to false positive errors when fingerprinting countermeasures such as heavily padding document content or dynamically altering word content (such as with foreign character sets) causes content variation to be distributed relatively evenly throughout a document.

When longer content chunks have been proposed in the prior art, such as using sentences as chunks, problems have been noted by Brin, et al, for example, in accurately detecting sentence boundaries of documents translated into plain text versions from other document formats, potentially affecting match accuracy. Ambiguous boundary definitions arise for other reasons, such as language structure, but should not pose a problem if the chunking method is applied consistently for all chunked documents.

In “Finding Similar Files in a Large File System” (Manbur, Udi, 1994, Proceedings of the USENIX Winter 1994 Technical Conference) a sparse subset of words or character strings in a document are selected as anchors and checksums of a following or surrounding fixed-length sequence of characters are computed. Similar files can then be detected by comparing checksums of other documents that have previously been registered in a database. This approach is mainly intended for detection of files that are very similar, but not for detecting small but significant text overlaps, such as a copy that contains only 50 characters of significant text duplication and 500 characters of randomly varied obfuscation text.

In U. Manber and G. Myers. Suffix arrays: A new method for on-line string searches. (Proceedings of 1st ACMSIAM Symposium on Discrete Algorithms, San Francisco, Calif., 1990), PAT trees and suffix arrays are suggested to find maximal common subsequences in documents. These methods attempt to solve a more difficult problem than determining simple text overlap and therefore are substantially more expensive in computational terms than hashing-based copy detection methods.

In “Parallel and Distributed Overlap Detection on the Web,”0 Monostori et al (2000), the authors propose a document copy detection method aimed at finding examples of plagiarism. The authors note the problem that exists in finding an appropriate document chunking primitive that balances copy detection ability with computational efficiency. The authors suggest a matching engine based on suffix trees representing only the ending characters of selected word-oriented character strings and finding the longest shared chunk of text between a sample document and an unclassified document. The disadvantage of this approach when applied to the problem of spam detection is that spam email messages may be intentionally padded with obfuscation content and therefore do not necessarily follow predictable language structures that enable suffixes to reliably represent the content of similar spam messages. Suffix trees would not be able to accurately represent the significant portions of obfuscated messages and this detection method would tend to produce a high rate of false negative errors.

In “Signature Extraction for Overlap Detection in Documents, (Finkel, et al (2001) the authors propose a copy detection method for identifying possible examples of plagiarism by finding the proportion of shared signatures or tokens contained within two documents. A relatively small number of selected document chunks or tokens, in digest form, are extracted from both sample documents and a suspicious document.

The method includes preprocessing documents by discarding all punctuation; tokenizing the residual content based on white spaces as boundaries; discarding all chunks that are either long or short to reduce the size of the index; digesting chunks using MD5 to reduce storage space; and comparing similarity based on the number of shared digests. With respect to spam filtering, the drawback of this method is that insertion or deletion of random content can affect the tokenizing of similar messages, causing misalignment of text. Discarding punctuation can reduce this effect but only partially because spammers can use a wide variety of variable non-punctuation content to disrupt patterns in similar messages composing a spam broadcast. Another drawback is that obfuscation notwithstanding, relatively long chunks tend to have greater matching value than small chunks, and if large chunks are discarded, matching effectiveness may be reduced.

In “Copy detection mechanisms for digital documents,” (S. Brin, J. Davis, and H. Garcia-Molina. In Proceedings of the ACM SIGMOD Annual Conference, San Francisco, Calif., May, 1995) the authors propose a system for detecting potentially plagiarized documents in which suspicious documents and registered documents are both broken into chunks, such as words, sentences or paragraphs. Each chunk is hashed and hashes are compared between the documents to identify matching chunks. The authors note that some difficulties arise in accurately identifying sentence boundaries in documents translated from different formats and whenever non-word structures occur, such as “Sect. 3.2.6.” However the authors conclude that if a large enough sample of sentences is used to represent a document then inconsistencies in sentence boundary detection may not significantly affect the identification of matching sentences in similar documents. The authors employ a random sampling technique of extracted sentences to reduce the sample size to a more manageable set. The present invention does not use random sampling of chunks.

In N. Shivakumar, H. Garcia-Molina, SCAM: A Copy Detection Mechanism for Digital Documents. (Proceedings of the 2nd International Conference on Theory and Practice of Digital Libraries, Austin, Tex., 1995) the authors describe a document comparison scheme based on word occurrence frequencies found in compared documents. Words are said to be easier to detect than sentences, and hence are a more accurate basis for comparing documents. As the authors point out, one disadvantage of using words as the chunking unit is a higher false positive error rate than a sentence-based approach. This effect occurs because true document overlap becomes more difficult to determine when chunks contained in two documents are small. While word chunking enables finer (partial) content overlap among documents, short character sequences, such as words, are more likely to appear in unrelated documents than longer character sequences, such as sentences or paragraphs, leading to higher false positive errors if words are chosen as chunks. Two unrelated documents, such as email messages, may contain the word “click” or “free” but may not be contained within the same sentences. Characters contained within word-based chunks inevitably contain less information than an equivalent number of characters contained in longer strings such as sentences because the greater amount of information about character sequence relationships in longer character strings is partially lost when breaking a document into smaller chunks. To address this problem the authors use a weighting scheme that combines relative word frequencies and a cosine similarity measure. Nevertheless the result is a higher level of false positive errors compared to the sentence-based chunking system used by Brin et al, particularly with short documents. Another drawback of the word-based chunking approach is the larger data storage requirements (approximately 30% to 65% of the original documents, depending upon the chunking method used), which makes the infrastructure costs to support a working system quite high. Another disadvantage is that whenever word boundaries are obfuscated or content consists of document structures that are not natural words, the system may fail.

In N. Shivakumar, H. Garcia-Molina: Building a Scalable and Accurate Copy Detection Mechanism (Proceedings of 1st ACM International Conference on Digital Libraries (DL'96) March 1996, Bethesda Md.) the authors propose a copy detection mechanism for detecting illegal copies of documents in digital libraries. They show that performance and accuracy vary widely for different chunking mechanisms, making it important to evaluate and understand various chunking options. The authors adopt non-overlapping sequences of words with hashed breakpoints as a compromise that avoids the phasing problem that results from n-word sequences, while having lower storage costs than overlapping word sequences. This scheme works as follows. Start by hashing the first word in the document. If the hash value modulo k is equal to zero (for some chosen k), the first chunk is merely the first word. If not, consider the second word. If its hash value modulo k is zero, the first two words are considered the chunk. If not, continue to consider the subsequent words until some word has a hash value modulo k equal to zero, and the sequence of words from the previous chunk break until this word will constitute the chunk. The overlap between two documents is computed as the number of such shared chunks.

This method can be subverted if used as the basis for spam filtering whenever the overall document is constructed with a high level of obfuscation that disrupts the expected word patterns. In a simple case two documents that each contain ten words of significant content and also contain 90 words of randomized and different content may not be estimated as being similar, even thought the significant content may be exactly the same. This problem occurs when obfuscation content is present in a document and has not been identified as such so that it can be ignored.

In Heintze, N. “Scalable Document Fingerprinting” (pub. after 1996) Bell Laboratories, Murray Hill, N.J.) http://www-2.cs.cmu.edu/afs/cs/user/nch/www/koala/main.html a method of document similarity detection is taught using fixed size selective fingerprints based on document substrings. The method requires selecting a set of subsequences of characters from a document and generating a fingerprint based on the hash values of these subsequences. Similarity between two documents is measured by counting the number of common subsequences in fingerprints. Vowels are stripped as a preprocessing step. The substrings consist of twenty character sequences of consonants and all characters are converted to lower case. Given the typical distribution of consonants in most words, a subsequence of twenty consonants corresponds to spans of about 30-45 characters, including vowels and consonants, in the original document. By considering only consonants, the Heintze approach is not actually based on document substrings, but rather on character subsequences of the original document.

Since Heintze is interested in fingerprinting potentially plagiarized documents that typically are of significantly greater length than email messages, the technique reduces the size of the resulting fingerprint set by selecting a subset of the substrings from the full fingerprint. Since the author's goal is to detect plagiarism among documents that vary in size from several thousand words to several hundred thousand words under tight disk space constraints, a fixed number of substrings are chosen, independent of the size of the document. The author terms this approach “fixed size selective fingerprinting.” The selection of substrings is based on a substring frequency measure according to the first five letters of a substring. Heintze assumes that the distribution of five letter sequences in a specific document follows the same general distribution of five letter sequences in other documents.

There are several drawbacks of such an approach that would manifest themselves if applied to the problem of detecting spam email messages. The first drawback is that a count of common sequences may give a biased result of similarity if the selected sequences are not adequately representative of the significant and recurring content that is common to duplicated but obfuscated messages. Non-representative sequences can result whenever obfuscation content exists in a message but is not identified and becomes part of the set of fingerprints.

A second drawback is that some email messages, including short messages, are too short in length to produce a meaningful representation with a set of fixed-size fingerprints unless the selected substrings are very short. In this case it would be easy to subvert such a system by making minute changes, such as adding or substituting a few characters to each otherwise identical copy of a message in order to influence the fingerprints.

A third drawback is that selecting a subset of fingerprints, regardless of the method chosen for selecting them, can cause loss of potentially significant information that would affect a classification decision, especially with short documents such as the typical email message.

In Broder, et al. “Syntactic Clustering of the Web,” (1996 Digital Equipment Corporation and University of Arizona, pp. 1-13) the authors treat each document as a sequence of words and decompose it into a series of word sequence chunks. Documents are preprocessed to ignore minor details including formatting, HTML commands, and capitalization. For example, the phrase “a,rose,is,a,rose,is,a,rose” would be broken down into a sets of chunks consisting of each successive grouping of four consecutive words: (a,rose,is,a), (rose,is,a,rose), and ,(is,a,rose,is). The authors then select a random permutation of the resulting n-word sequences to reduce the computational requirements for estimating similarity. The first drawback of this approach is that the use of short and overlapping substrings can be too sensitive to relatively small textual differences, such as the differences that are commonly inserted by spam message authors who actively seek to thwart fingerprint-based detection systems. A related drawback is that a random sampling approach to culling the substring set can fail to include enough significant content to find a match if the content has been sufficiently camouflaged with an intermixture of obfuscation content.

In U.S. Pat. No. 6,349,296 issued to Broder, et al (2002) a method is disclosed for determining the resemblance of data objects such as Web pages. Each data object is partitioned into a sequence of tokens. The tokens are grouped into overlapping sets of the tokens to form shingles. Each shingle is represented by a unique identification element encoded as a fingerprint. A minimum element from each of the images of the set of fingerprints associated with a document under each of a plurality of pseudo random permutations of the set of all fingerprints are selected to generate a sketch of each data object. The sketches characterize the resemblance of the data objects. The sketches can be further partitioned into a plurality of groups. Each group is fingerprinted to form a feature. Data objects that share more than a certain numbers of features are estimated to be nearly identical. The drawbacks in this case are the same as those cited in the previous example of prior art. A probabilistic sampling approach could cause significant data to be overlooked if the sampling procedure creates an overly sparse subset. This could occur if the document content is deliberately padded with non-payload information or other obfuscation techniques are used to disguise the significant content.

U.S. Pat. No. 5,418,951 issued to Damashek (1995) teaches a method of identifying, retrieving, or sorting documents by language or topic involving the steps of creating an n-gram array for each document in a database, parsing an unidentified document or query into consecutive and overlapping n-grams, assigning a weight to each n-gram based on its frequency of occurrence in a document, removing the commonality from the n-grams, comparing each unidentified document or query to each database document, scoring the unidentified document or query against each database document for similarity, and based on the similarity score, identifying retrieving, or sorting the document or query with respect to language or topic.

Use of n-grams, as a document chunking tactic, is easy for a spammer to subvert by making random additions, substitutions and deletions in a document in order to disrupt the chunk patterns from one copy of a document to another. Spammers can alter or pad document content in dynamic and unexpected ways to evade similarity detection. Adding, subtracting or substituting even one primitive unit, such as a character or a word, depending on the chunking primitive used, causes a shift in chunk boundaries. Another disadvantage is that extracting and storing overlapping n-grams is computationally expensive. An additional drawback is that n-gram-based chunking will tend to produce false positive errors as the size of chunks is reduced, especially if the target application is more demanding than language or topic identification and instead has a more specific goal of finding similar documents.

Combined Filtering Approaches

Many filtering systems combine different approaches in an attempt to overcome the deficiencies of any single approach. A popular spam filtering software product that exemplifies the combined approach is SpamAssassin. (See description at http://www-106.ibm.com/developerworks/linux/library/l-spam/). A drawback of this multi-layered approach is that if the results of different layers of detection are used in an additive fashion, as if often the case, any single method that is prone to false positive errors will still tend to produce those errors regardless of whether it functions separately or as part of a combination of various spam tests. In essence, an additive approach that combines multiple detection methods inherits the highest false positive error rate of any single method.

Use of Human Intervention to Improve Filter Operation

Spam message authors exploit the gap between software intelligence and human intelligence in their efforts to outwit the pattern-matching systems described in the prior art and frequently succeed in their efforts. Humans can readily comprehend even highly obfuscated spam messages if the obfuscation is done in a sufficiently subtle manner, which is a result that benefits the spammer but causes users of spam filters to achieve unsatisfactory results. Therefore it would be advantageous to incorporate human intelligence into the process of interpreting spam messages in order to improve the spam identification capability of a spam filter. While implementing manual screening of all messages received would be prohibitively expensive, reviews of sample messages that are used as case examples would be advantageous if the reviews could be used to produce more intelligent and discriminating automated filtering algorithms.

The prior art in spam filtering includes methods of using human message inspectors to compensate for the problems of complex content obfuscation techniques characteristic of some spam messages. However, the use of human intelligence has been limited to assisting in the development of improved spam models, not improved spam case repositories. Brightmail™ (“Brightmail struggles daily to block spam,” San Francisco Chronicle, Jul. 13, 2003 http://sfgate.com/cgi-bin/article.cgi?f=/c/a/2003/07/13/BU174579.DTL) and Mail-Filters™ are examples of commercial spam filtering services that use human reviewers to inspect sample email messages. Sample messages are acquired through various means and presented for evaluation by a reviewer. Generally the reviews serve to determine whether a message sample matches a specified definition of spam and to identify one or more message features that can be incorporated into a rule set. If a message is judged to be non-spam in character it is ignored, otherwise a filtering rule update is formulated from an inspection of the message.

Because most of Brightmail's spam filter rules are created automatically by the software, only exceptions are subjected to human review. A drawback of this approach is that if a rule created by automation is flawed it may cause filtering errors, errors which could be prevented if a human evaluation and adjustment were employed before rule deployment. If the automated rule-generation procedure is flawed, exceptions may not be reviewed in a timely fashion, or possibly not at all if the errors are false positive errors. If a false positive error occurs no one may notice that a messages was incorrectly tagged as spam so the need for a filter rule update may never be noticed by the service provider. The human reviews practiced by Brightmail do not extend to a complete semantic assessment of consistently defined and preprocessed chunks of message body content, which, if used, would help separate variable obfuscating content from significant and recurring content. Nor does the assessment include a topical labeling of the samples or the content features that define the topics of a document. Without such a feature it is impossible to topically classify unclassified messages that are found to share content in common with previously reviewed sample messages. Another disadvantage of Brightmail's method is that some message features other than substrings found in message bodies are used as filtering criteria, including subject line content and sender identities. The disadvantage of this approach is that too many false negative errors will occur since spam senders can easily vary these message features, while false positive errors may occur since non-spam messages may contain similar subject lines or sources of origin relative to spam messages.

Similarly, the email filtering products and services offered by Mail-Filters.com include human reviews of collected spam message samples. Human reviewers inspect the messages to identify phrases that are considered likely to appear in other spam messages and add rules to a spam signature database in order to identify messages containing the same phrases. While in some cases a phrase-based spam identification rule may include more than one phrase, leading to higher content overlap than if only a single phrase were used, this method does not attempt to identify all the recurring content of a message, so the content matching strategy is sub-optimal. In essence the content-matching strategy of Mail-Filters.com, like Brightmail's, is model-based, not case-based, so the use of human inspection of messages is applied to adding to a composite list of spam features rather than adding a specific example of a spam messages to a set of spam examples. As with Brightmail™, a further drawback of Mail-Filters' approach is their reliance upon message features other than message body content, including subject line rules, sender ID rules and message header content rules. These additional filtering tactics can lead to filtering errors as described previously. Additionally, Mail-Filters.com deploys at least some automatically created filtering rules, potentially causing errors since the rules are not evaluated with human intelligence.

In U.S. Pat. No. 5,983,246 issued to Takano a generalized method is disclosed for classifying documents by comparing portions of their content to documents that have previously been collected and classified. The classification of sample documents occurs through a combination of manual and automated means, resulting in a word frequency distribution model. Takano teaches that manual document classification of some documents or all but one document in a document classification may be assigned to document creators to take advantage of superior knowledge of the contents of documents they have created. The assumption behind this feature is that document authors may be trusted to use their own knowledge of their documents to classify their documents with greater accuracy than if classifications were performed by others, such as service provider. The drawback of this approach is that in some cases authors may deliberately misclassify documents they have authored in order to hinder classification by automated document analysis systems, such as plagiarism detection systems, resume classification systems, Web page indexing systems or junk email filtering systems. The present invention does not feature a method by which document creators may annotate or classify their own documents, thereby avoiding the drawback of biased document classification. The present invention also does not employ a keyword frequency distribution model to estimate document similarity.

Conclusions Regarding Prior Art

Spam filtering, as one type of document classification problem, is characterized by potentially many copies, near copies, or substantively similar copies of the same document being transmitted across a network within a short time period, so time is of the essence in detecting spam messages. Another characteristic of the spam problem that makes it somewhat different than other document classification problems is that users of email systems have relatively low tolerance for false positive errors, while having somewhat differing opinions about message topics that constitute unwanted or junk email. Prior art solutions are not sufficiently detailed or intelligent in their methods of classifying email messages, particularly when it comes to classifying dynamically obfuscated spam patterns and, as a result, make too many false positive and false negative errors.

A main reason for the shortcomings of the prior art methods is that they do not provide a reliable way to determine which portions of a document are likely to be semantically significant from the point of view of a document sender or recipient and are therefore susceptible to document camouflage techniques. Another shortcoming of the prior art is that classification decisions about documents tend to be binary, limiting the ability of such systems to scale across users. It would be desirable to customize message classification across a group of users so that different user opinions about message classifications, based on message content, could be provided for different users.

Given the drawbacks of the prior art, there is a need for a system that can detect most spam while making fewer false positive errors. The fact that the definition of spam is somewhat subjective means that practical solutions must provide support for user choice about how the filter classifies messages at the individual level. There is also a need to update the filtering process by providing it with new patterns in a way that reduces or eliminates any burden on end users to provide this function and detects new patterns before spam reaches end users.

Objects and Advantages

A first and general object of the present invention is to provide a means of accurately classifying electronically distributed documents, such as email messages, on the basis of their similarity to other documents.

Other, more detailed objects of the invention are as listed below.

A second object of the present invention is to produce accurate email message classification results without using the conventional and error-prone means of relying on message source (header) information, an interpretation of message delivery behavior, a filtering list of keywords or keyphrases, or use of a statistical model of a message class.

A third object of the invention is to achieve accurate message classification by using a message classification method that is case-based rather than rule-based, employing a set of previously collected and classified bulk email messages samples as cases against which unclassified messages are compared.

A fourth object of the invention is to enable the bulk email sample repository upon which classifications are based to update itself quickly in response to the existence of new bulk messages within a network, without reliance upon active human intervention to collect and contribute samples of new bulk email broadcasts.

A fifth object of the invention is to efficiently incorporate human cognitive abilities into the process of semantically classifying all sample message content, thereby further enhancing the system's message classification reliability and providing support for reliable and user-customizable topical filtering features of the system.

A sixth object of the invention is to render classification computations with enough speed and efficiency to avoid significant processing costs or delays in the delivery of email messages to their recipients.

An seventh object of the invention is to function with little to no intervention by users of the system in order to adjust, train, correct or otherwise modify the operation of the filter once it is installed.

An eighth object of the invention is to maintain the privacy of email communications by limiting human review and classification of email messages to sample messages that are collected with end user permission and are used to populate the bulk email sample repository.

A ninth object of the invention is to provide an email filtering system that can be extended, without great effort, to related message filtering applications such as wireless short messaging services and instant messaging services.

A tenth object of the invention is to provide an email filtering system that can process messages successfully in any language without modification to the software other than modifying or extending a set of document parsing and stripping rules.

An eleventh object of the invention is to provide an email filtering system that may be operated independently by and for an individual domain of users or, alternatively, may be operated by a service provider who provides bulk email filtering services for a group of users or domains of users on a network, such as the Internet.

Further objects and advantages of the invention will become apparent from a consideration of the drawings and ensuing description.

### SUMMARY OF INVENTION

The present invention provides a system and method of document similarity detection and classification. In a preferred embodiment the invention may be used to classify email messages in support of a message filtering or classification objective. The invention employs a case-based classification method, as opposed to a model-based approach, thereby contributing to a reduced false positive error rate compared to other methods.

Content chunks of an unclassified document are compared to the sets of content chunks comprising each of a set of previously classified sample documents in order to determine a highest level of resemblance between an unclassified document and any of a set of previously classified documents. The sample documents have been manually reviewed and annotated to distinguish document classifications and to distinguish significant content chunks from insignificant content chunks. Significant content chunks are those that are likely to appear in similar documents, as opposed to content chunks that are specific to an individual copy of a document. The annotations are used in the similarity comparison process.

If a significant resemblance level exceeding a predetermined threshold is detected, the classification of the most significantly resembling sample document is assigned to the unclassified document. Many document classifications may be supported, providing a means of customizing applications that use the classification output for different purposes and different users.

Both sample documents and unclassified documents are automatically processed by first removing insignificant content, according to a content significance rule set. Documents then are partitioned into a set of content chunks according to a content chunk rule set. Chunks then may have additional content removed according to additional content significance rules that are dependent on chunk types.

To detect document similarity based on the resulting content chunks, a ratio is calculated. The ratio expresses the proportion of characters contained in semantically significant document chunks that are present in the sample document and also are present in the unclassified document, with this result divided by the total number of characters contained in all semantically significant chunks in the sample document.

The result is a relative measure of overlap of semantically significant chunks, which is then compared to a predetermined minimum overlap threshold value to gauge whether the measured overlap is sufficient to provide a classification decision. If the threshold is met or exceeded the unclassified document is assigned a classification according to that of the sample document with which it shares at least the minimum level of semantically significant chunk overlap. If the threshold value is not exceeded then a null classification or other non-specific classification is assigned to the unclassified document.

Sample documents are manually reviewed as they are acquired in order to classify them and to classify their individual document components or chunks. Classification judgments are electronically recorded and made a part of sample document profiles so that the additive information may be considered during subsequent automated similarity detection processes. Sample documents are tested prior to review for similarity to previously reviewed documents. Unreviewed samples that are found to be excessively similar to previously reviewed documents are rejected in order to prevent redundant reviews of closely resembling documents.

Sample documents may be acquired by automatically testing unclassified documents existent in a network, such as a flow of email messages, for a lack of similarity to previously classified documents combined with similarity to other unclassified documents. Unclassified documents matching these two conditions are formed into clusters. A representative sample from a cluster of similar unclassified documents is subjected to the manual review process to determine a classification for its contents. The selected sample document is added to the sample document repository. Any other documents that resemble the selected sample document may subsequently be classified as the same as the selected sample document. In this way sample documents may be acquired without imposing a burden on end users of the classification system to actively provide sample documents to the classification system.

The repository of sample document profiles, in combination with the document stripping, chunking and chunk ratio comparison computer code, may be deployed in a variety of configurations to evaluate a batch or stream of sample documents, such as a stream of email messages, to classify the documents. The classification decision may be recorded by inserting a code into a classified document or may be passed to another document processing system, such as an email server, as an instruction for handling a document according to its classification code value.

### BRIEF DESCRIPTION OF DRAWINGS

FIG. 1 illustrates a computer network divided into a service provider network section and a user network section.

FIG. 2 illustrates the major processes occurring in the service provider network.

FIG. 3 illustrates the major content types characteristic of an email message.

FIG. 4 presents an example of an email message document in a parsed form reflecting the finger model of the present invention.

FIG. 5 illustrates the handprinting process of the present invention.

FIG. 6 provides a detailed view of the document similarity measurement process utilizing handprint comparison.

FIG. 7 illustrates a prior art process of automatically capturing manually generated annotations from a workstation operated by a human operator.

FIG. 8 illustrates a prior art manual document review user interface illustrative of a screen display of an annotatable sample message file.

FIG. 9 illustrates the message classification and handling process operative in a user network according to the preferred embodiment.

FIG. 10 illustrates the proper alignment of FIGS. 10A, 10B and 10C.

FIGS. 10A-10C illustrate the process for acquiring message samples that are evidently bulk email messages but are not sufficiently similar to previously classified messages to be classified as any particular type of email message.

### DETAILED DESCRIPTION

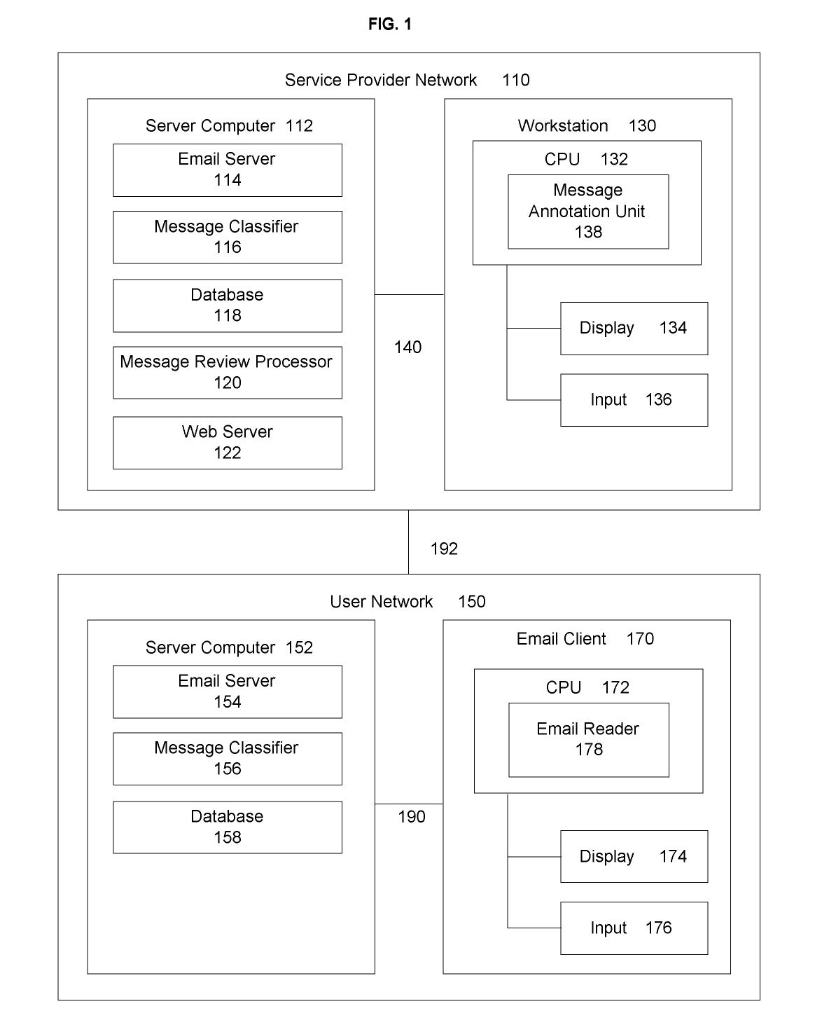

In a preferred embodiment the document classification system is operated in conjunction with an email messaging system where the unclassified documents to be automatically classified are email messages, although other document classification applications are possible. FIG. 1 illustrates the components of a computer network that may be employed as means of operating the invention in the preferred embodiment. The inventive system is comprised of computer code, operating on several computers connected via a network, that supports four primary processes:

1. A process for managing and maintaining a service provider's information repository comprised in part of sample documents (sample messages) and information derived from them;

2. A process for automatically updating a user network copy of a portion of the information repository;

3. A process for classifying email messages as they are delivered to the user network and providing classification information to the user email server or other message processing system in order to effect a message handling decision; and

4. A process for acquiring and classifying new sample messages from the flow of unclassified messages received in the user network in order to update the local or central repository.

The components of the system and the apparatus by which it may be implemented in a preferred embodiment are illustrated in FIG. 1. FIG. 1 illustrates a computer network divided into a service provider network section 110 and user network section 150. The service provider network 110 supports classification of sample messages and share information about classified sample messages with the user network 150 by way of a network connection 192. In a preferred embodiment the network connection 192 is provided by a linkage through an external network of computers such as the Internet.

In an alternative embodiment, the present invention can be implemented without a service provider. A single domain, such as a large corporation or ISP, could implement a sample message classification process of its own, without reliance on a third party service provider.

The service provider network 110 includes at least one server computer 112 that has installed on it several software components, including an email server software unit 114 (“email server”), a message classifier software unit 116 (“message classifier”), a database storage software unit 118 (“database”), a message review processor unit 120 (“message review processor”), and a Web server unit 122 (“web server”). The database 118 stores several types of information in a structured format, including information about sample messages. The web server 122 manages the flow of information between the message review processor 120 and the message annotation unit 138 described below. The software components 114-122 may be installed separately on two or more linked server computer devices to enhance performance, but are illustrated as being installed on one server computer 112 for simplicity of illustration. The server computer 112 is connected to an external network 192, such as the Internet, so that it may exchange data with external sources.

The service provider network 110 includes at least one client computer 130 (“workstation”) connected to the server computer 112. The workstation 130 includes a CPU 132, a display device 134 such as a computer monitor, and at least one input device 136 such as a keyboard and a computer mouse-pointing device. The workstation 130 has installed on it a message annotation unit 138 which is a software program capable of receiving a file, displaying the file, accepting manually entered file annotation inputs, and transmitting data reflecting the inputted annotations associated with a file. In a preferred embodiment the message annotation unit 138 is a software program known as a Web browser of a widely known type. In a preferred embodiment the workstation 130 is connected via a local area network connection 140 to the server computer 112 but also may be connected by an external network 192 such as the Internet.

The user network 150 illustrated in FIG. 1 includes a server computer device 152 that has installed on it an email server software unit 154 (“email server”), a message classifier unit 156 (“message classifier”) of the same type included in the service provider's network 110, and a database storage unit 158 (“database”) of the same type included in the service provider's network 110. The software components 154-158 may be installed separately on two or more linked server computer devices to enhance performance, but are illustrated as being installed on one server computer 152 for simplicity of illustration. The server computer 152 is connected to an external network 192, such as the Internet, so that it may exchange data with external sources.

The user network also includes at least one email client device 170, typically taking the form of a desktop computer or other computing device capable of receiving email messages. The email client device includes a CPU 172, a display device 174 such as a computer monitor, and at least one input device 176 such as a keyboard and a computer mouse-pointing device. The email client device 170 has installed on it an email client software unit 178 (“email reader”) for sending and receiving email messages.

Operation—Preferred Embodiment

In the preferred embodiment as an email classification system, the service provider network 110 processes sample message documents and the user network 150 processes unclassified email messages in order to classify them according to their calculated significant similarity to sample messages.

Service Provider Processes

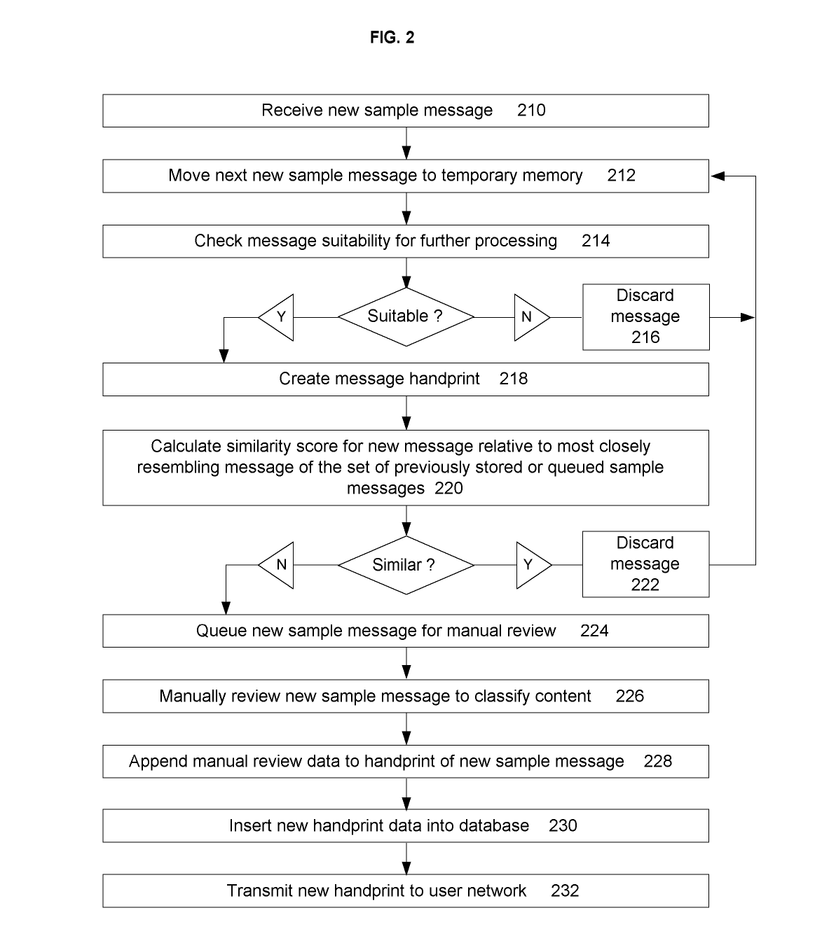

FIG. 2 illustrates the major processes occurring in the service provider network 110. At step 210 a new sample message is received. A preferred method of gathering new sample messages will be described below, although any of a variety of methods may be used, including accepting copies of messages addressed to inactive, abandoned or non-existent email accounts, as is well-known by those skilled in the art. Regardless of the sources of sample messages, each message is gathered at a designated email address controlled by the service provider and located on the email server 114 of FIG. 1. In the preferred embodiment sample messages are stored in the file directory system of the server computer 112, which functions as a holding queue for messages that require further processing, while the message review processor keeps track of the status and location of each message. In an alternative embodiment sample messages may be stored in the database 118.

The message review processor 120 of FIG. 1 periodically checks the holding queue for new sample messages. In step 212, if a new sample message is present it is removed from the queue and is stored in temporary memory. Optionally, at step 214, predetermined message attributes may be checked as an initial test of suitability for further processing. If the message attribute to be tested matches a predetermined condition, such as excessive message size, the message is discarded at step 216, otherwise processing continues. Empirical evidence suggests that discarding large messages spares unnecessary subsequent processing because junk email messages are nearly always below a predetermined file size that may be established by empirical analysis.

In a preferred embodiment each sample message is checked to identify and discard new sample messages that are duplicates of or substantially similar to previously received sample messages. This aspect of the present invention enables the service provider to avoid redundant processing of duplicate or near-duplicate sample messages, which is particularly important since some of the processing is done by a manual document review and electronic annotation process. The process by which duplicated or substantially similar sample messages are recognized in the incoming sample message flow is essentially the same as that used to classify messages received by the user network 150, employing the message classification techniques of the present invention.

Messages that are not discarded at step 216 and are suitable for further processing are subjected to a process called “handprinting.” The sample message is processed to create a handprint at step 218. Using the handprint information, a similarity score ratio is calculated at step 220 to determine if the new sample message is similar to a previously received sample message. If the similarity score ratio is equal to or higher than a predetermined value, the new sample message is discarded at step 222 and processing continues with the next new sample message at step 212. If the new sample message has a similarity score ratio lower than a predetermined value, at step 224 the message is queued for manual review.

At step 226 the new sample message is manually reviewed to classify its message content. At step 228 data reflecting the results of the manual review step are appended to the handprint data. At step 230 the handprint data is inserted into the database 118 of FIG. 1 as a new handprint. At step 232 of FIG. 2, whenever a new handprint data record is stored in the service provider's database 118 a copy of the new handprint is transmitted automatically to the user network 150.

Management of Sample Message Information Repository Processes

A more detailed explanation of the processes of managing and maintaining the service provider's database 118 of sample message information will now be provided. The processes include:

1) Creating handprints, or profiles representing a set of partial document content features of sample messages;

2) Measuring the similarity of new sample message handprints to those of previously submitted and stored samples messages and discarding new sample messages that are judged to be duplicates or near duplicates of previously submitted sample messages;

3) Supporting manual review and annotation of non-duplicate sample message handprints;

4) Capturing subjective document feature annotation values produced by the manual review step and storing the annotation values in association with each new sample message handprint.

The present invention uses a document “handprinting” process, which profiles a document using a set of digitally fingerprinted “fingers” representing partial content features of a document. Each finger represents a partial document content feature that has been extracted according to one or more document parsing rules. Comparing multiple aspects of two documents using the finger model and handprinting process of the present invention supports detection of partial but significant document similarities. In the “case-based” similarity detection method of the present invention, a collection of previously received, classified, handprinted and stored email documents serves as a pattern base. By manually identifying content in each sample message that probably is recurring content in other messages, similarly processed new email messages may be compared to the sample email documents and classified according to the classifications of the collected sample documents.

The Finger Model

In order to understand the handprinting process it is necessary to review the “finger model” of the present invention. The goal of the finger model is to provide a consistent framework for profiling documents, such as email messages, so that partial and significant document similarities, or “content payloads” can be detected and accurately measured. The underlying assumption is that similar documents, such as bulk email messages, are characterized by having at least some recurring “payload” content that is found in all versions of a broadcast or collection of similar message documents.

The finger model provides a consistent, flexible and comprehensive framework for representing and comparing potentially duplicated and significant sample document (message) features. The model employs a set of rules for extracting information from a document, such as an email message, into a set of content chunks that collectively may be digitally fingerprinted and formed into a “handprint” profile of a message.

A set of document content decoding rules and partial document content removal rules may be employed to remove some types of document content at various stages of the overall process in order to improve the results. The resulting document profile, or handprint, represents a sample document feature set or an unclassified document feature set. A variety of chunk types are defined by the model, with each chunk type termed a “finger type.” Collectively the “extracted fingers” of information that relate to each finger type may be used to fingerprint a document. The set of fingerprinted fingers becomes the handprint representing each document's content. The model also makes use of predefined document metadata types to assist in the comparison and interpretation of document fingers.

Finger Types

Finger types representative of the finger model, and the methods of identifying the finger types, are now described.

“Paragraph fingers” are strings of characters representing portions of email message bodies, excluding any file attachments and other body content finger types (such as link fingers). Paragraph fingers may be extracted from both text MIME parts and HTML MIME parts of email message bodies. “Paragraph fingers” are not, strictly speaking, paragraphs in a grammatical or literal sense. Paragraph fingers are non-overlapping strings of text contained within message body MIME parts that are separated by consistently recognizable boundaries such as line break characters found in text MIME parts and HTML tags found within HTML MIME parts. There may be more than one paragraph finger per message body MIME part. Very short paragraphs may be discarded or combined with adjacent paragraph fingers. Hypertext links contained within email messages are not considered paragraph fingers. HTML formatting tags, metatags, and the text strings contained within them also are not considered paragraph fingers. Paragraph fingers are defined in a way that enables extraction of text substrings from a document that are generally longer than individual words but usually are substantially shorter than the entire text of a message MIME part. Extracting text substrings of an intermediate and variable length enables the handprinting process to extract a significant number of relatively lengthy text chunks. The advantage of extracting a significant number of chunks is that partial document content overlap may be more easily detected without being overly sensitive to small changes in otherwise duplicated messages.

In an alternative embodiment, paragraph fingers may be limited in length by imposing limits on the minimum and/or maximum numbers of characters that may be contained in an individual paragraph finger. When the normal paragraph finger parsing rule would produce an excessively short or long paragraph finger, the paragraph finger may be reformed by concatenating it with a next paragraph finger to increase its length, or truncating it to reduce its length. In any case the process of adjusting the length of a paragraph finger should refrain from creating fingers that overlap other fingers, even if the overlap would be only partial. Non-overlapping finger content is necessary to make the scoring system described below result in reliable classification decisions.

In another alternative embodiment, features that approximate the structure of a word, such as chunks of text surrounded by white spaces or other predetermined boundary points, may be employed. These contiguous word-based chunks of text serve the same function as paragraph fingers described above. Since they will tend to be substantially shorter in length than paragraph fingers, word-oriented fingers cause some loss of document information that is inherent in the character sequence relationships of longer text strings. To mitigate this problem and provide greater granularity of document content representation, word-oriented fingers may have index values or sequence numbers associated with them reflecting their relative order of appearance within a document. The use of more granular document chunking that is offered by smaller and more numerous word-oriented features, in combination with word sequence information, enables more strict matching conditions to be enforced when comparing documents than conventional word-oriented chunking approaches permit. The high resolution view of the document contents provided by smaller document chunks such as word-oriented features is helpful when noise content in the documents to be processed, such as noise words, represents a high proportion of total document content, is distributed relatively evenly throughout a document, and must be identified and suppressed with precision.

“Link fingers” are substrings conforming to the pattern of a hypertext link and can exist within text MIME parts and HTML MIME parts. Link fingers contained within HTML MIME parts can be recognized by the types of HTML tags that contain them. An HTML parsing algorithm of a type known to those skilled in the art may be used to isolate links within HTML MIME parts. Link fingers contained within text MIME parts can be recognized by text character sequences that conform to standard Internet hypertext addressing rules. For example, a word-like or paragraph-like character substring beginning with the character sequence “http://” conforms to the pattern of a link finger.

As a performance enhancement, duplicate link fingers extracted from a single message may be eliminated so that only one of the duplicates need be stored and processed.

In a preferred embodiment, link fingers can be further subdivided into link subfingers, based on typical boundaries separating portions of link fingers such as slashes, periods, asterisks and other common boundary characters of links. Subdividing link fingers into subfingers provides greater granularity to the similarity detection process, which sometimes is needed to expose recurring content contained in links that is partially obscured by variable content within links. For example, the hypertext link shown below is presented in an original form that would appear in an email message and in a parsed form enabling its components to be individually represented as their own set of link sub-fingers.

Original form of a link:

http://48ik0d9@www.topdollar.com/gem/?mikemc@abletekinc.com

Parsed form (broken into five link subfingers):

http://

48ik0d9@

www.topdollar.com/

gem/

?mikemc@

abletekinc.com

Some of the variable elements depicted in the above example may be removed by link content stripping processes discussed below. However some types of variable and obfuscating link content are not easily identified via automation and may require human intervention to identify them. Variable path elements of a link are an example of this phenomenon. The granular view of a link illustrated above is useful to the similarity detection process of the present invention whenever variation of link fingers across similar messages includes variation in a path element of a link rather than in a parameter element. A path element that can be automatically varied by a spam email sender, for example, would be the substring “gem” illustrated above. In another message this element may be automatically replaced with a different string of characters in order to camouflage the link, even though the alternative string of characters might not change the file that is referenced by the overall link, or might reference an identical file to the one referenced by the above link. The granular view of the link supports selective identification and suppression of obfuscating content of this type.

“Attachment fingers” are comprised of information about files attached to an email message. In a preferred embodiment, attachment fingers are defined by the content comprising the attachments. For example, the attachment content or a set of character substrings or subsequences extracted from an attachment can be hashed and stored as attachment content fingerprints. An image file is an example of an attachment finger that could be processed in this manner. HTML documents sometimes are included as a file attachment, with a reference to the attachment included within another part of the message. These attachments can be parsed and treated as the HTML part of the message rather than as an attachment.

In an alternative embodiment, metadata related to an attachment can be used as an alternative type of attachment finger. Examples of such alternative attachment fingers that use metadata include attachment name, file size, file extension type or location reference (a string within a message indicating the location within an overall message where the attachment content can be found).

Executable files that are found attached to spam samples may be computer viruses. If the attachment is an executable file type its presence can be reflected using a possible virus attachment finger that is set to a specific value based on the attached file type. In a preferred embodiment other types of attachments are ignored but the rules for utilizing information about attachments can be modified to suit changing needs.

“Significant fingers” are substrings that initially are given a classification of another type, such as a paragraph finger or a link finger, and are determined through a manual review process to be semantically significant content that most likely is present in other similar messages. “Significant fingers” are not necessarily indicative of the topic of a message.

“Topic-identifying fingers” are substrings that initially are given a classification of another type, such as a paragraph finger or a link finger, and are determined through a manual review process to be semantically significant content that most likely is present in other similar messages and also are indicative of the topic of a message.

“Call-to-action fingers” are substrings that initially are given a classification of another type, such as a paragraph finger or a link finger, and are determined through a manual review process to be a call-to-action finger. This type of finger expresses a means by which a message recipient may contact a message sender or an entity mentioned in a message's content, such as a vendor's Web page link. Call-to-action fingers may include Web site addresses, email addresses, phone numbers or postal addresses. They may sometimes be recognized by text structure (if they consist of a link or phone number). Since text may be found within messages that conforms to call-to-action patterns but really is not call-to-action text, automated detection would be error prone. In a preferred embodiment call-to-action fingers are manually identified and classified during the manual message review process.

“Noise fingers” represent content chunks within messages containing insignificant character sequences or subsequences, usually consisting of either personalizing or obfuscating content. Noise content varies from one similar message to the next, and is called “noise” to distinguish it from content that recurs in similar messages, which may be though of as the common “signal” characterizing all messages within a particular bulk email broadcast. While some insignificant or obfuscating content may be removed by an automated document noise stripping process, described below, any residual noise content causes an entire paragraph or link finger to be considered a noise finger that is not useful for similarity detection purposes. In a preferred embodiment noise fingers are recognized and reclassified from another finger type during the manual message review process. A finger carrying a “noise” annotation value has been subjectively classified to be of a semantically insignificant or obfuscating content classification.

“Code fingers” are character sequences representing executable program code content, such as JavaScript code. Code fingers are detected by the character sequence patterns of the program code itself or by descriptive tags associated with program code, such as <SCRIPT> and </SCRIPT> tags used to enclosed JavaScript program code within HTML documents.

A “linked document finger” is a finger containing the content of a separate document, such as an image file, text file, HTML file, multimedia file or executable program file that is stored at a remote location and is referenced in an email message by a link or hypertext reference, such an a URL. Reading the contents of a linked document finger requires an automated method of accessing the linked file by following the link to the location of the file on a network, downloading a copy of the linked document and evaluating its content according to a linked document finger processing algorithm. This finger type is useful in the event that messages composing an email broadcast contain nothing but dynamically varied content, resulting in an inability to obtain a match with functionally similar messages. If such messages also contain one or more links to remotely stored documents that feature at least some non-variable content then those remotely stored documents can serve as a basis for identifying and classifying varied messages comprising a broadcast. In such cases an evaluation of the varied message content is determined manually during the review process described below.

Handprints representing linked documents are stored in the handprint repository. When an unclassified message is encountered and cannot be classified by the preferred embodiment method of the present invention, in an additional embodiment the unclassified message may be subjected to a secondary classification process. This secondary process judges the classification of the unclassified message at least partially on the basis of a previously assigned classification given to a manually reviewed, handprinted and stored linked document copy.

This approach enables the linked document finger to provide a means external to the message itself of classifying a message that is internally camouflaged to a very high degree. As an optimization feature, this secondary test need not be performed in all cases in which a document cannot be conclusively classified. Instead it can be performed only when certain conditions are met, such as when the unclassified document is not similar to previously classified documents, contains at least one link finger and the link finger does not match a link on a list of “safe” links that are considered indicative of messages that do not require classification.

“Blank fingers” contain no characters at all and are produced whenever a message is encountered that has an empty message body MIME part or whenever the stripping procedure described below causes removal of all content of a message body MIME part. Blank fingers are always ignored in the similarity detection process.

Certain document metadata is extracted from each message during the handprinting process:

a) The message size is derived from a count of the text elements comprising the message body MIME parts. It is useful for comparing messages according to the quantity of total content within each message. In a preferred embodiment the number of characters in all message body fingers of a message, excluding stripped characters and noise characters, is calculated during handprint processing and comparison steps.

b) A finger count is derived and is useful for comparing the number of fingers in one message to the number of fingers in another message.

c) The message recipient address is extracted from the message header and is useful for finding a personalizing element of a message that contributes to its noise content so that it may be stripped.

It is not necessary to use all of the finger types mentioned above, and additional or alternative finger types may be defined according to the characteristics of the documents to be classified.

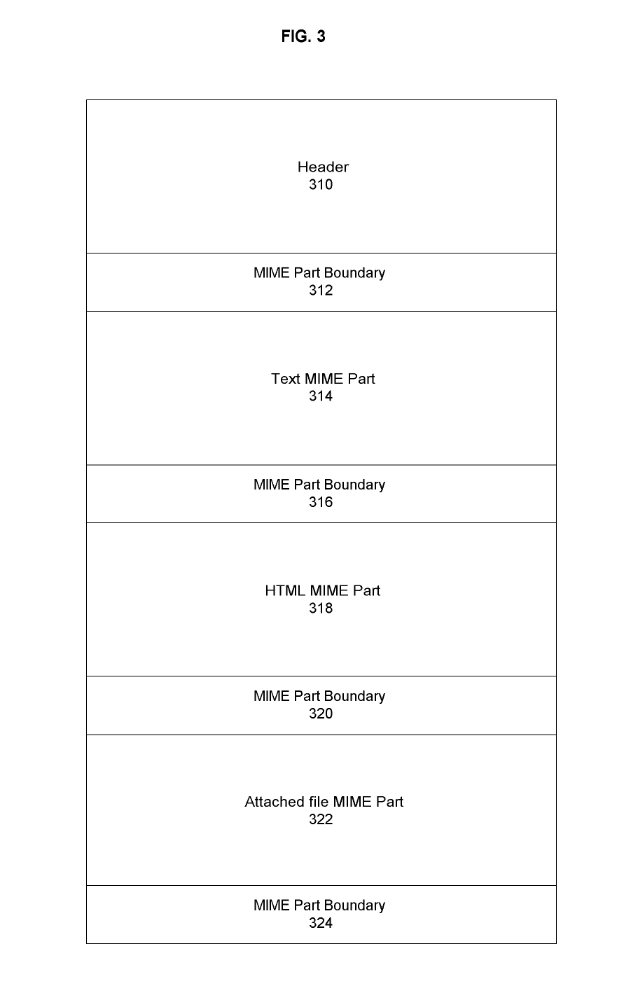

FIG. 3 illustrates the major content types characteristic of an email message as is known to those skilled in the art. The handprinting method of the present invention requires identifying each content type that may exist in a message and processing each part as a separate data entity before fingers may be identified and extracted. A message may consist of a header section 310, and at least one message body MIME part section (“MIME part”), such as a text MIME part 314 or an HTML MIME part 318. Both these MIME part types may be present in a message. The message may also include one or more attached files 322 as an additional MIME part. Each section of the message is detectable by finding sequences of characters known to those skilled in the art as MIME part boundaries 312, 316, 320 and 324. These boundaries may be detected and used by the present invention to identify the MIME parts of a message that are to be extracted and further processed. In some messages MIME parts contain other MIME parts, known as nested MIME parts. The method of the present invention treats each MIME part contained in another MIME part as a separate entity.

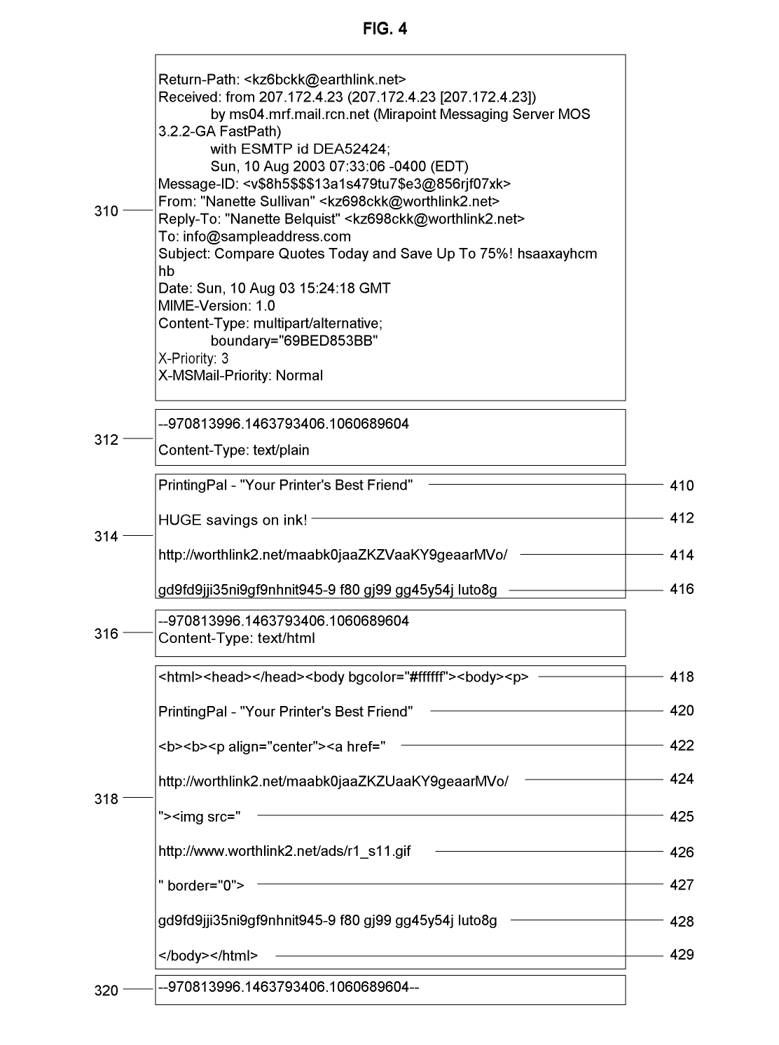

FIG. 4 presents an example of an email message document in a parsed form reflecting the finger model as described above. The message contains the features 310-320 described in FIG. 3. No file attachment 322 and no MIME part boundary 324 following the attachment are included, for simplicity of illustration. Some examples illustrative of paragraph fingers 410, 412, 416, 420 and 428 and link fingers 414, 424 and 426 are provided in FIG. 4. The character sequences 418, 422, 425, 427 and 429 are HTML formatting tags that are not considered either paragraph or link fingers. In the preferred embodiment, these HTML tags are to be stripped from the document during the handprinting process. In an alternative embodiment HTML formatting tags and metatags may be used as fingers and used in the similarity detection process. The paragraph fingers 416 and 428 give the appearance of being noise fingers because their content would not appear to add any significant meaning to the overall content of the message when reviewed by a human reviewer or message recipient. In all likelihood this type of content has been deliberately inserted to subvert a document fingerprinting system by varying the content in otherwise similar messages. As mentioned earlier, in an alternative embodiment a link finger may be further parsed into link sub-fingers using characters such as “/”, “@”, “.” and “?” as boundary points between sub-fingers composing a string of text that matches the pattern of a link.

It will be understood from the foregoing description of the finger model that it is a flexible, consistent and comprehensive method of representing document structure. The finger model may define document content chunks according to syntactic rules common to a document or document type, such as a word or hypertext link, as well as arbitrarily selected document chunk definitions, including configurable chunk length limits and chunk boundary definitions. The handprinting and similarity detection processes of the present invention also may incorporate document metadata reflecting a document's intrinsic features as well as reflecting its relationships to other documents and their features.

In an alternative embodiment, more than one content chunking rule may be applied, producing more than one set of fingers representing document content. For example, a non-link finger of a document may be broken into a set of paragraph chunks and separately broken into a separate set of word-oriented chunks. Two sets of fingers may then be evaluated to produce two sets of similarity measurements relative to sample messages which have similarly been broken into two sets of fingers, simultaneously providing alternative document profiles.

In an alternative embodiment, fingers can be defined differently according to one or more attributes of a message, such as the size of a message.

Creating handprints, or profiles representing message samplesThe process of deriving a message handprint from a message now will be described. This process is performed by the message classifier unit 156 of FIG. 1 and is the applied in essentially the same manner for handprinting unclassified messages in a user network 150.

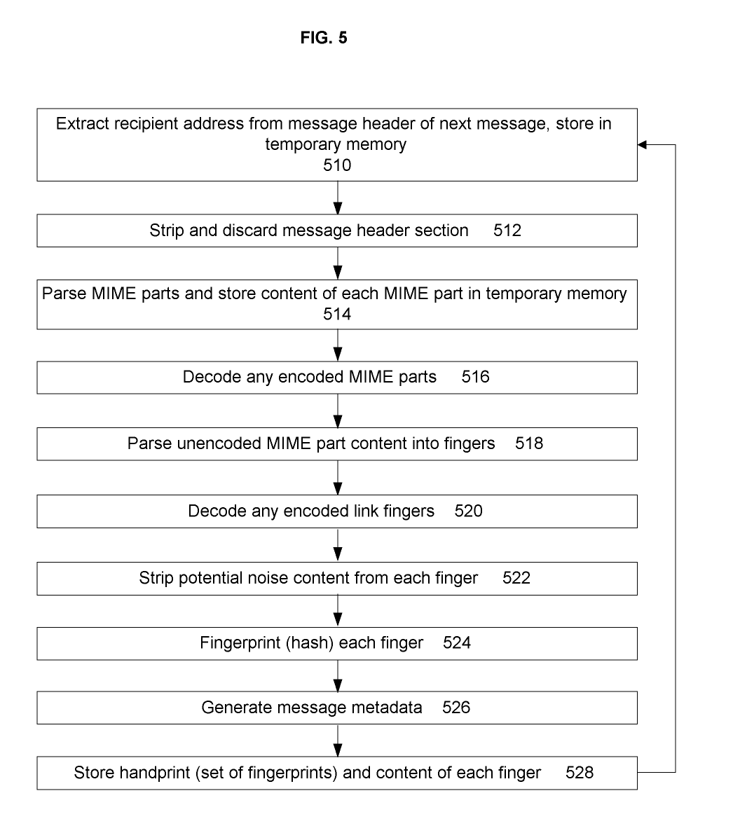

As illustrated in FIG. 5, the handprinting process begins at step 510 in which the recipient address is extracted from the header section of the message and is stored in temporary memory. At step 512 the header portion of the new sample message is discarded. At step 514 the MIME parts of the message are detected by the presence of MIME part boundary text elements as is understood by those skilled in the art. Further, the character string or strings comprising the message body content of each MIME part are parsed and held in temporary memory so that each string is available for additional processing.

At step 516 each MIME part string is decoded if it is determined to exist in an encoded form. Some messages may include encoded MIME parts, using, for example, an encoding scheme such as Base 64. Any encoded MIME parts are decoded after their MIME part boundaries are detected to convert them to plain text or, if the MIME part represents and HTML document, to an HTML document format. If decoding is necessary it is accomplished using well-known decoding algorithms required for the type of encoding scheme represented by a particular MIME part's content. After any necessary decoding is completed the process of parsing MIME part contents into message body “fingers,” or message body substrings, can begin.

The parsed MIME parts that have been decoded at step 516 if necessary, are parsed into fingers at step 518 of FIG. 5 according to the finger definition and document parsing rules described above. The full content of each extracted MIME part is read by the message classifier 116 of FIG. 1. When text boundaries or text string patterns are found that indicate that a finger of a particular type has been detected, its text is copied to temporary memory for further processing and the resulting data structure is classified as a finger of a certain type. The message classifier unit continues reading the content of the MIME part until the next finger is detected, repeats the extraction and temporary storage of the text as a finger, and continues this process until all the text of the message has been processed into fingers.

After all fingers have been extracted according to step 518 of FIG. 5, at step 520, any link fingers are decoded if they have been obfuscated via an encoding scheme. Encoded links in email messages usually represent a form of content obfuscation practiced by spam message senders. Encoding the same or similar links in a different way in each of a set of broadcasted messages takes advantage of the ability of Web servers that process links to find and serve HTML documents after decoding any encoded link. Encoding the same links in different ways in different versions of a spam message creates varied message forms with a functionally identical but superficially varied call-to-action type of link.

As an example, a link finger may be encoded into hexadecimal form, so that the link

http://www.angelfire.com@www.cybergateway.net/spammer/index.html#3491371628/2creditc/index.html

is rendered in an encoded and variable form from one message to another, such as

http://www.angelfire.com %40%77w %77%2e%63yb%65%72%67atew%61%79%2e%6e%65%74/s%70%61%6d%6d%65r/% 69%6Ed%65%78.%68%74m%6C#3491371628/%32c%72%65%64%69%74c/%69%6Ed%65%78.%68%74m%6C

This type of link obfuscation tactic, and others similar to it, may be automatically recognized by the message classification unit 116 and the obfuscated link may be converted to a non-obfuscated form using algorithms well known to those skilled in the art. Once this decoding is completed, or if no decoding is necessary for a link, processing passes to step 522.

Noise Stripping

At step 522 potential insignificant or noise content that may be present in certain fingers is stripped. Noise data includes text that is of a personalizing or obfuscating nature, or is non-essential to conveying the essential meaning of an email message to a recipient. Many bulk email messages, particularly spam messages, include dynamically generated personalizing or obfuscating content that differs within each partial copy of a message, while all the messages composing a broadcast contain some common content as well. Separate finger-level stripping rules for removing such content are necessary because different types of fingers can contain different types of noise content. Content that might be considered noise in one type of finger is considered valid content in other types of fingers. For example, numbers contained within words, sentences or paragraphs typically have low significance to a message's meaning and often are used to camouflage the content of a spam message from fingerprinting systems. Removing such content from paragraph fingers seldom would have a significant effect on the ability of the message to convey its meaning to a human reader, but may significantly improve the ability of the present invention to expose significant message similarities. However, numbers contained within links can sometimes be valid content serving as significant message identifiers, depending on their location within the structure of a link. It is necessary to discriminate between these different types of noise for different types of fingers to avoid stripping out vital content from fingers that is needed to successfully find partial matches.

The finger definitions and stripping procedures may be adapted to content in different languages by creating rules for finger boundaries and content stripping that are specific to any given language.

Paragraph fingers are stripped by removing blank spaces, carriage returns and all non-alpha characters. In an alternative embodiment, any phone numbers recognizable as phone numbers may be extracted and retained as possible call-to-action fingers. Upper case characters are converted to lower case. Full and/or partial email addresses (name and/or name@domain) that match the message recipient data extracted from the message header are stripped. The resulting paragraph fingers contain only lower case alphabetical characters.

Link fingers, including URLs pointing to remotely stored or attached HTML documents or other types of files, are stripped of any program parameters, which typically are detected by the presence of a question mark or similar delimiter. Delimiter characters and any content following a delimiter is stripped. Any remaining email addresses and email aliases embedded within URLs and located within a URL are stripped. Any content located between an “@” symbol located before a top-level domain name and a leading “http://” string or similar protocol indicator is stripped. Any content up to and including a “redirection” delimiter such as the string “rd*” is stripped. Other potential noise contained within URLs may be stripped according to an empirical analysis of URLs that would otherwise successfully subvert the link stripping process.

In an alternative embodiment the processing of link fingers may proceed after first decomposing links into link sub-fingers comprising portions of link fingers.

Call-to-action fingers, including links (URLs and email addresses), phone numbers or postal addresses, are stripped as follows. URLs are stripped as described above, before it is known whether a particular URL is a call-to-action URL. Phone numbers, as a call-to-action finger type, are recognized during the paragraph strip step and retained as possible call-to-action text subject to manual inspection and verification described below. Phone numbers are stripped by converting them to a common form through removal of extraneous characters such as dashes, spaces, parentheses and periods.

It is possible that not all the noise content contained within a message will be detected and removed through the automated stripping processes described above.

Residual noise can be detected later during the manual inspection step so that fingers containing variable noise can be so classified and ignored during comparisons to other messages.

Fingerprinting

Returning to FIG. 5, after each message body finger is identified and its potential noise elements removed, control passes to step 524 at which the residual (stripped) character subsequences of each message body finger are converted to a short, fixed-length digest value. In a preferred embodiment the well-known MD5 hashing algorithm is employed owing to its fast computer processing implementation and low likelihood of producing the same hash code value for different strings of text.

At step 526 additional message metadata are generated.

At step 528 the fingerprints for each message body finger are then stored, along with a message ID code, as part of a database record representing a profile of the message, or a “handprint.”

The information extracted from the new sample message and stored in temporary memory includes, at this point in the process, the following data:

1) A pointer to the file location where a copy of the original message is to be stored;

2) The individual unstripped fingers extracted from the message, which are not used for similarity detection but are used as a feature of the user interface of the manual review process described below;

3) The individual stripped fingers extracted from the message;

4) The fingerprints (such as hash code values) representing each individual finger;

5) The number of characters contained in each finger, excluding any noise characters that have been stripped and including any common fingers;

6) The total number of message body characters contained in all the content fingers, excluding any noise characters that have been stripped and including any common fingers;

7) Labels indicating the finger type of each finger.

Additional data will be added to the handprint data set of a new sample message after a message is manually reviewed, as described below.

Document Similarity Measurement

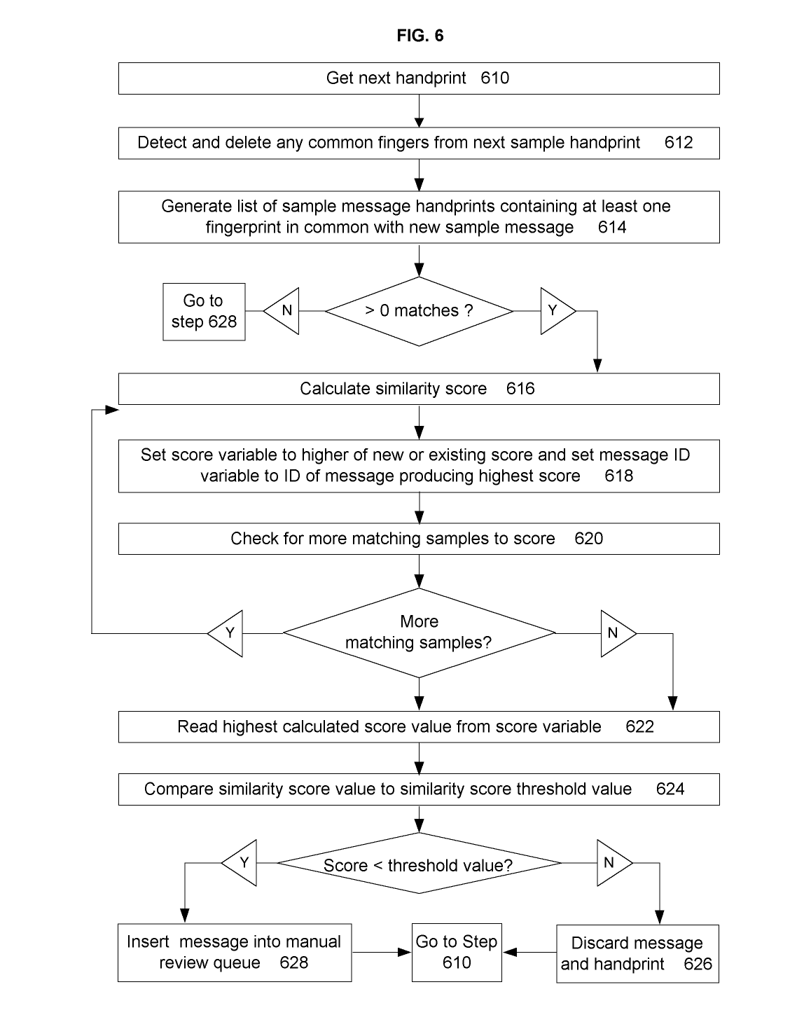

After a handprint is created for a new sample message it is possible to compare the message to previously handprinted and classified messages by comparing the data sets of their respective handprints. The similarity measurement process is performed by the message classifier 116 of FIG. 2. FIG. 6 provides a detailed view of the document similarity measurement process utilizing handprint comparison.

As illustrated in FIG. 6, the handprinting process begins at step 610 by getting the next handprint (as created in FIG. 5) to compare to each of the handprints in the database 118.

Processing continues at step 612 where any “common fingers” of the handprint are detected and, if present, deleted. The advantage of deleting common fingers is to improve performance by reducing the number of insignificantly matching handprints retrieved from the database when comparing the handprint of a new message to the handprints of existing sample messages. Common fingers do not significantly aid in classifying messages and therefore, as a performance enhancement, can be safely ignored. Common fingers are identified by looking up the hash codes of each finger in a list of common finger hash codes. A database table including a list of common fingers and their hash codes is maintained by the system administrator in temporary memory or in the program code of the message classifier 116 for this purpose. The list is built using an empirical knowledge of documents to be classified, by periodically querying the handprint database to determine the most common fingers, or by reviewing new sample messages that appear as duplicates in the sample message review queue that are not automatically discarded by automation. A common finger in an email message might be, for example, the text substring “Hello,” which may appear so frequently in messages of different categories that it does not aid in classifying messages.

After deleting any common fingers, the remaining fingerprints of the new sample message are then used as the basis for a database query. At step 614 of FIG. 6 the database 118 of FIG. 2 is queried to generate a list of all previously classified and stored sample message handprints that potentially represent significant matches to the new sample message. The query uses all the non-common fingerprints from the new sample message as a compound set of query conditions. The query returns a list of all sample message handprints that contain at least one fingerprint matching a fingerprint belonging to the new sample message. Any handprint listed in the results of this query represents a partially resembling sample document due to common partial document content features contained within it relative to the new sample message.

Optionally, the query can be preceded by a finger de-duplication step, in which the fingers of the new sample message are checked for duplicate fingers composing the message, and any duplicates are eliminated. This step reduces the subsequent processing of handprint similarity calculations.

If no partial message matches are identified the new sample is considered a non-duplicate with respect to the set of existing sample messages based on sample message handprints stored in the database 118. If this condition occurs then control passes to 628 and the new sample message is inserted into the manual message review queue. If there is at least one match the similarity measurement process continues at step 616

Applying the above-described weighting scheme, at step 616 a similarity score ratio is computed for a first pairing of the new sample message's handprint and the handprint of a first existing sample message in the database that shares at least one non-common finger with the new sample message. The similarity score ratio is a weighted ratio of matching partial document content features that have been previously classified as significant partial document content features of the sample message. The ratio has as its numerator a count of non-noise text characters contained in fingers of the new sample message that match non-noise fingers found within the paired sample message from the database.

Non-noise fingers contained in sample messages from the database are identifiable by subjective classification labels associated with each finger. These labels are generated as a result of the manual sample message review process described below. The denominator of the similarity score ratio is the total number of non-noise characters contained in all the significant fingers of the previously reviewed and stored sample message.

At step 618 a score variable that keeps track of the highest score et aclculated for the subject message is set to the higher of the newly calculated score value or a pre-existing score value, if any. At the same time a message ID variable is set to the message ID number of the sample message that has thus far produced the highest match score.

In an alternative embodiment the similarity measurement procedure compares a count of matching fingers in each paired message, preferably expressed as a ratio of matching fingers divided by the total number of fingers ins the sample message.

At step 620, a check is performed to determine if there is another sample message handprint with at least one matching finger relative to the fingers of the new sample message handprint. If there are no additional pairings to be evaluated control passes to step 622. Otherwise control passes back to step 616, where the next pairing of the new sample message handprint and a previously classified sample message handprint with at least one matching finger is scored. The process continues at step 618, where the resulting score ratio variable is reset to the highest score value yet found among all paired message handprints, while the message ID variable is set to the message ID of the sample message that has thus far produced the highest match score. The process of scoring each successive pairing of a new sample message handprint and existing sample message handprints that partially match the new sample message handprint continues until the all possible pairings have been scored.

As a performance enhancement it is advantageous to interrupt the series of scoring calculations whenever any pair consisting of a new sample message handprint and an existing sample message handprint produces a score that meets or exceeds a given minimum similarity threshold value. The advantage of including this “stop looking” rule is that whenever any scored pair exhibits a highly significant level of similarity, further processing to find one or more pairs that might exhibit an even higher similarity score ratio adds little value to the overall process. Interrupting the evaluation of additional pairs once at least one significant match is found thereby saves time and computational resources. The value of the “stop looking” threshold may be set by the system administrator based on an empirical knowledge of score significance.

At step 622 the score value stored within the score variable is retained as the highest and final similarity score ratio and the sample message handprint which produced this highest score value has its message ID number read and stored.

Once the highest similarity score ratio is determined, it is compared at step 624 to a predetermined minimum similarity threshold value. If the threshold value is met or exceeded by the measured similarity score ratio, the new sample message is considered significantly similar to a previously reviewed and stored sample message. In this case the new sample message and its handprint are discarded at step 626 and control passes to step 610 where a similarity measurement of a next new sample message handprint commences. If the measured similarity score ratio falls below the threshold value, any similarity of the new sample message to an existing sample message is considered insignificant. The similarity threshold value may be determined through empirical observations by the service provider by analyzing the lowest possible value that detects insignificant partial duplicates without discarding significant partial duplicates.

In an alternative embodiment, different similarity threshold values may be applied to messages of different types. For example, a higher similarity threshold value may be applied to short messages than the threshold value applied to longer messages. This technique applies a more stringent test of message similarity in cases where there is less information available to make a similarity decision, thereby reducing the possibility of making a false positive error.

The similarity measurement process as applied to sample messages being evaluated by the service provider is applied twice—once to determine whether a sample message is significantly similar to a message already stored in the sample message database and again to determine whether the same new sample message is significantly similar to a message that currently is queued for manual review. If a significant similarity measurement value is discovered in either case the new sample message is discarded. If a new sample message handprint is not discarded on the basis of either similarity comparison it will be inserted at step 628 into the manual review queue for further processing. As well, the message from which the handprint was derived is archived. Control then passes to step 610 where the similarity measurement process may be applied to a next new sample message.

The result of the handprinting of samples is a “trial” handprint or document profile produced entirely by automation. In the subsequent manual review process the handprint may be altered by further interpretation of the content and by adding subjective classification labels to the handprint representing human semantic judgments at the document level and at the finger level. This additive information, incorporated into the handprint as metadata, may shift the weights given to each finger and therefore can provide a more precise definition of a sample message's significant (non-noise) content. The effect of altering finger weights through the use of the additive information described below is improved ability of the system to identify semantically significant matches.

Supporting Manual Review and Annotation of Non-Duplicate Sample Message Handprints

Each sample message that has been judged by the similarity measurement process described above as significantly different from any previously classified sample messages is individually reviewed and annotated by a human operator. Incorporating a human review step into the sample document classification process produces a net benefit to the functioning of the system. The cost in terms of time and effort of performing manual reviews of each message is substantially mitigated by three factors. First, the time required to review each message is quite brief (usually a few seconds per message). Second, only substantially new sample messages require review because duplicates or near duplicates are discarded through the process described above. Substantially new messages typically represent only a small fraction of total bulk email messages because the vast majority of bulk email messages are repeatedly broadcast in an unchanged or similar form. Third, the costs of manual sample message reviews can be spread across a potentially large user population, making the average cost per user quite small. The benefits of human reviews include more accurate sample message classification than possible by entirely automated means and reliable identification of noise content, which enables the similarity detection process to operate more effectively.

The present invention incorporates the prior art disclosed in U.S. Pat. Application No. 60/471003 as a method of supporting manual document reviews and annotation of sample documents such as email messages. As has been taught in the prior art, a client/server network means of controlling a structured document annotation process is employed. One or more human operators who are trained according to a predetermined message classification policy are each provided with a workstation 130 of FIG. 2. The workstation 130 is used to display new sample messages and to capture and record a set of structured document annotation values selected and inputted by a human operator.

As taught by the prior art, the client workstation used to support manual message reviews includes a message annotation unit 138 as illustrated in FIG. 2. This unit, in a preferred embodiment, takes the form of a Web browser application of a widely known type. The browser is capable of communicating a request for a file to a Web server 122 coupled with the message review processor 120. A detailed explanation of the steps involved in the message management review process is provided in the prior art. An overview of the functions as they are applied by the present invention to reviewing sample email messages is now provided.

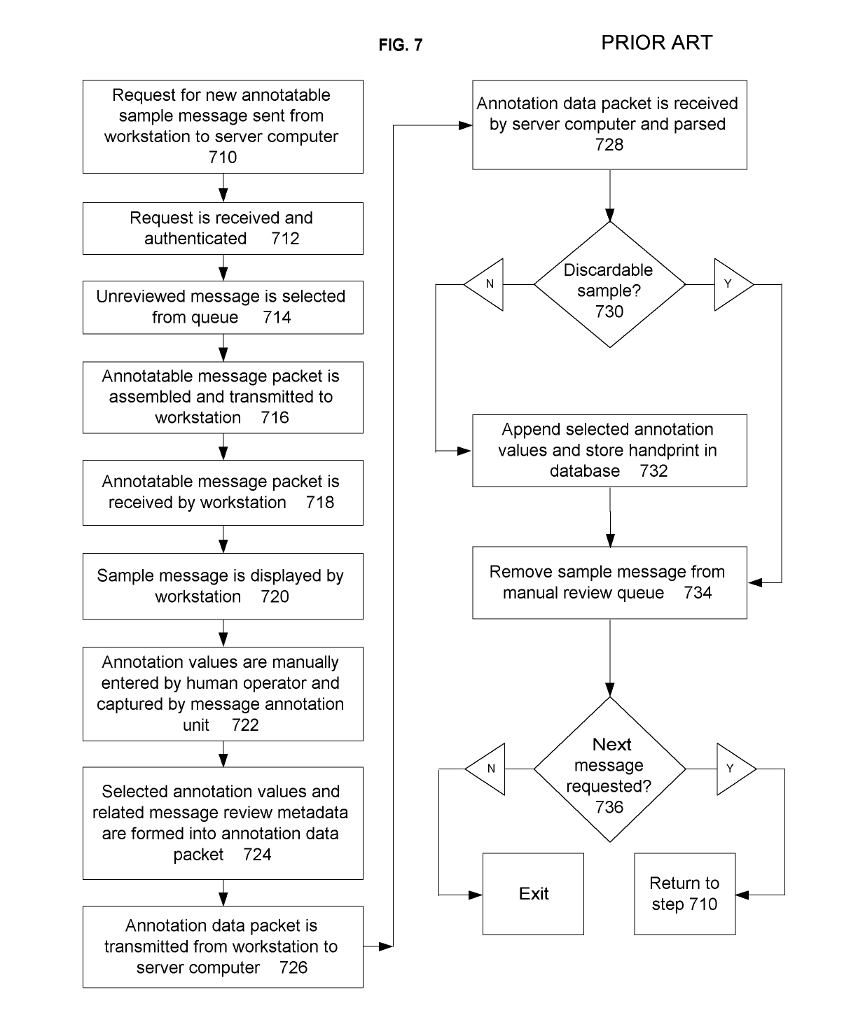

FIG. 7 illustrates the steps involved in managing the process of automatically capturing manually generated document annotation values (message annotation values) from a workstation 130 operated by a human operator. At step 710 an electronic request to receive a new sample message to review and annotate is sent from the workstation 130 to the server computer 112. The request is received and authenticated by the Web server 122 at step 712. The Web server communicates with the message review processor 120 to obtain an annotatable message packet. At step 714 a sample message that has been placed into a queue of one or more messages awaiting review is selected. The selection criterion may be random order, oldest message in the queue, most duplicated or partially duplicated messages in the queue, or another criterion chosen by the service provider.

At step 716 the handprint information of the selected new sample message and formatting information to display the message information are formed into an annotatable message data packet, passed to the Web server, which then transmits the data packet to the requesting workstation 130. This packet takes the form of an HTML document that includes the message body finger content of the new sample message, its associated handprint information, and instructions for formatting the display of the message in an annotatable form at the workstation 130.

At step 718 the annotatable message data packet is received by the workstation 130 and at step 720 is displayed for viewing as an HTML file in a default format on the display device 136. The file includes a link control, such as a hypertext linked URL, that is displayed on the display device so that operator may request and receive a display of related files, such as view of the same message in an alternative view or format. For example, an annotatable view of a sample message may include a link to a non-annotatable view that includes a view that is similar in appearance to the way the message would appear to an email message recipient in its original form.

After the human operator reviews and judges the content of the message, at step 722 the human operator manually inputs one or more selectable document annotation values by interacting with graphically displayed interactive controls associated with the displayed sample message content and, in a preferred embodiment, with controls associated with individual fingers of the sample message. The operator selects a message classification value and finger classification values from a set of predetermined classification values. Other review tasks may be added to support more refined or extended message review and processing objectives.

At step 724 the selected and inputted sample message annotation values are formed into a annotation data packet, including the message ID code, a message classification value, finger ID codes, and finger classification code values. The annotation data packet also includes additional information, such as a time stamp, an operator ID code, and a code indicating whether another sample message should be transmitted to the workstation 130 of FIG. 2. At step 726 of FIG. 7 the annotation data packet is transmitted to the server computer 112 of FIG. 2.

Capturing and Storing Message Classification Annotation Values

At step 728 the Web server 122 accepts the annotation data packet, passes it to the message review processor 120, where the data packet is parsed into its individual data elements.

At step 730 a message classification annotation value is read to determine whether the message is of a discardable classification, such as a personal email message classification, indicating a type of message that has inadvertently been submitted to the service provider's sample message classification address. During this step a code value contained in the annotation data packet is read and temporarily stored to determine whether another sample message should be sent for review. If the message classification value indicates a personal, null or other discardable non-bulk email classification, the new sample message and its handprint may be discarded at step 734, otherwise control passes to step 732.

At step 732 the individual annotation data elements of a sample message not classified as discardable at step 730 are appended to the sample message handprint record and the handprint data record is inserted into the database 118 as an annotated sample document (message) record. At step 734 the message review processor removes the new sample message from the message review queue. At step 736 the code value that has been read at step 730 is evaluated to determine whether a next sample message has been requested by the workstation 130. If a next sample message has been requested, control passes back to step 714, otherwise processing terminates.

In an alternative embodiment each message may be required to undergo more than one review step, by more than one reviewer, as a means of identifying and correcting potential human errors. Various message characteristics, such as characteristics of known non-spam messages, may be used to determine whether a new sample message should be subjected to more than one review. In this embodiment unanimous agreement on message reviews would be required in order for message reviews to be considered complete. Lack of unanimous agreement would trigger an alert, requiring administrator intervention to resolve a disputed review.

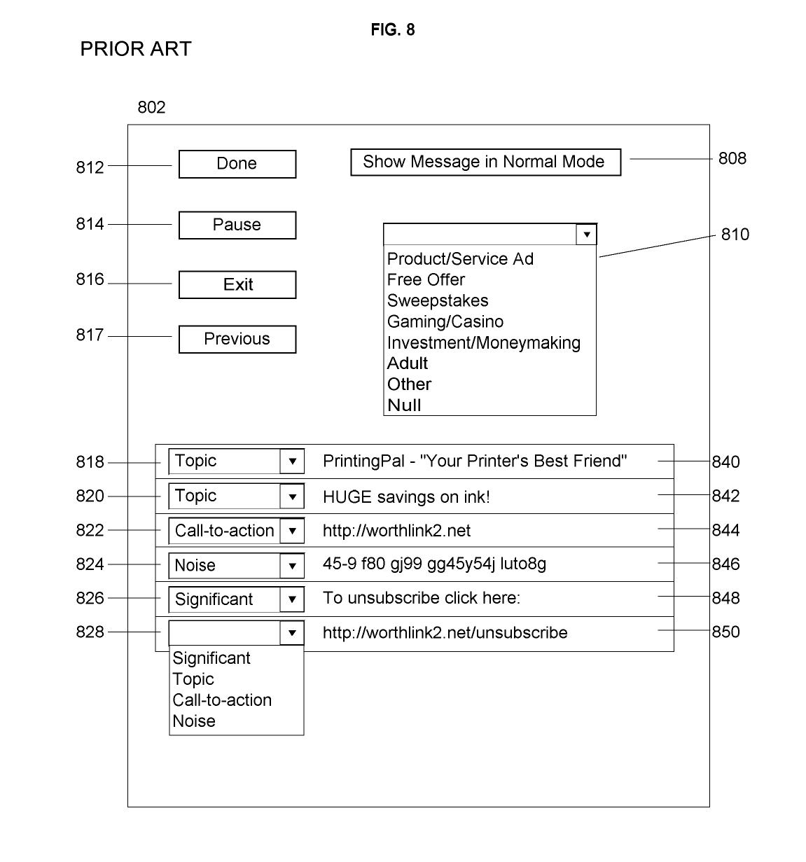

As taught by the prior art, FIG. 8 illustrates a manual document review user interface 802 illustrative of a screen display of an annotatable sample message file. This view of a sample message shows its content displayed as a vertically arrayed sequence of individual message body fingers 840-850. An interactive input control 810 to record a classification judgment about the document is provided. The document-level classifications may include a range of classification types. In one embodiment these classification types may be limited to a binary set of selectable annotation values and value labels, such as “spam” and “not spam.” In a preferred embodiment, the classification choices, while still tightly structured, are more varied in order to support a more granular classification scheme supportive of a more customizable message-handling objective.

As additionally illustrated in FIG. 8, an array of interactive input controls 818-828 are displayed in association with each individual finger of message content so that the human operator may select from a set of annotation values representing human judgments about the classification of each finger. The finger-level input controls may be configured to accept binary classifications (annotation values). An array of checkbox controls, for example, associated with each finger, can be employed to capture ajudgment such as “noise” or “not noise.” In a preferred embodiment as illustrated in FIG. 8, several selectable annotation value label choices are provided with each input control 818-928, using a graphical form control in the style of a drop-down list control. Input control 828 illustrates, for example, such a control in a clicked state offering a list of selectable annotation values or finger classification choices. This control format permits more than two classification choices, such as the mutually exclusive classifications of “significant,” “noise,” “call-to-action,” and “topic-identifying.” “Significant” fingers are considered significant because they are likely to appear in duplicated or partially duplicated message, but are neither “call to action” fingers” or “topic-identifying.” Identifying noise/non-noise finger distinctions via the manual review step enables suppression from comparisons of any residual noise not stripped via the automated stripping step and supports more intelligent matching processes. Identifying “call-to-action” fingers supports identification of possible variants of known bulk email messages in email message flows that have not been collected by other means, aiding in new sample acquisition. Identifying “topic-identifying” fingers enables more reliable estimation of the topical classification of an unclassified message based on the similarity of its fingers to the topic-signifying fingers of a previously classified sample message. This distinction takes on importance when messages include significant amounts of duplicated content that are “boiler plate,” i.e., are common to a variety of bulk email messages yet not indicative of its topic. An example would be a paragraph explaining how a recipient may unsubscribe from a distribution list, which may be present in substantially the same form in multiple bulk email message broadcasts of different topics.

In the preferred embodiment, messages that are judged to be of a “null” classification, which may include sample messages that are of a personal nature and not bulk email messages, may be processed by a human operator without requiring classification of individual fingers.

In FIG. 8 the message content is shown in its finger view, in which each paragraph and link finger 840-850 are displayed with vertical spaces between them, enabling them to be viewed as separate chunks of the original email message. However the fingers are displayed in an unstripped form, including spaces and punctuation, in order to aid the human operator in semantically evaluating the fingers. FIG. 8 also exhibits an interactive input control 808 that provides a means of requesting an alternative view of the message, such as a view similar to that seen by a message recipient. This alternative display is provided when the human operator clicks the interactive control 808, causing the message annotation unit 138 to request a file from the Web server 122, which is connected to the message review processor 120. The message review processor 120 then gets the data needed to construct an HTML file capable of rendering the sample message in its original format. This file is then passed to the Web server 122, transmitted to the requesting workstation 130 and displayed on the display device 134. The option to display the message in its original format affords the human operator with a means of viewing the message in a more easily comprehensible form. If the parsed finger view of the sample message is at all confusing to the operator, the normal view can clarify the operator's understanding of the content. The file representing the original format includes an interactive control that enables the human operator to resume a display of the message in its parsed form showing the finger-level view and associated annotation controls. Only the parsed view of the sample message includes controls enabling the human operator to express, record and transmit their judgments concerning the sample message.

In an alternative embodiment a view of original message may accompany the parsed finger view of the message in the same annotatable message packet. The human operator can shift between views of the finger view and originally formatted view of a sample message by adjusting the screen display view, such as by scrolling to a different location within a partially displayed Web page.

FIG. 8 illustrates additional controls that are provided to assist in the management of the manual review process. Control 812 is selected when the message and finger classifications have been inputted and the human operator wishes to both submit the selected values and to request a next annotatable message packet. Interactive controls 814 and 816 enable the human operator to terminate or pause a manual review session. A control to display a previously reviewed message 817 enables a human operator to request and obtain a display of a previously reviewed message so that the review results may be evaluated for errors and, if necessary, corrected and resubmitted by the human operator.

Other control screens that may be provided to facilitate management of the inspection process include a human reviewer log-in screen, a reference information display screen pertinent to the sample message review function and potentially other displays that support other review tasks. These tasks may include, among others, second reviews of other reviewers work (re-inspection) and sideby-side comparisons of similar samples which may assist a human operator in confirming suspected noise content through visual comparison of message pairs. Sample messages may be evaluated against various criteria established by the service provider to determine whether, for example, a second review of sample message is required, such as reviewing all messages twice if the total message length is below a certain maximum length.

When a human operator has completed inputting selected annotation values reflecting message content judgments, the operator selects one of the several interactive controls 812-816 signifying completion of a sample message review task and readiness to either review a next sample message, pause the review session or terminate the review session.

The structured classification judgments provided by the manual review process are incorporated into the handprint data structure so that subsequent comparisons of unclassified message handprints can determine which fingers should be considered as “noise” and therefore ignored in a sample message, which fingers are indicative of a sample message's topic and to which topic a sample document relates. Additional classification information, such as whether particular fingers are call-to-action fingers, or whether apparently significant fingers are really too variable across a group of related messages to be considered recurring, may also be obtained from the manual review process. Encoding this information in a structured manner enables subsequent document comparison process to produce more refined and accurate results.

Auto-update of remote copy of message handprint repository

In a preferred embodiment, the sample message handprint portion of the service provider's database 118 is copied and stored locally within the user network 150. This arrangement enables handprint queries associated with similarity measurement and classification of inbound email messages to occur with greater speed compared to querying a remotely stored database.

Since new sample message handprints are developed continuously, a method is needed to update the local copy of the handprint database so that it is refreshed at frequent intervals, providing a close approximation of real-time handprint updates. In a preferred embodiment the database update process occurs continuously by means of an automatic data replication step that incrementally updates the user network database 158 with any changes in the service provider's handprint database records that have occurred as new handprint data is entered into the service provider's system. The replication procedure uses a secure and continuously open network connection between the user network database 158 and the service provider's database 118. The service provider's database 118 automatically sends an update of new handprint data to the user network database 158 whenever any new handprint data are available, including new handprints to insert or to delete from the user network database 158 according to any changes in the contents of the service provider's database 118.

In an alternative embodiment, the update procedure may be implemented using a batch processing method that is well known to those skilled in the art. Computer code running on the user network's server computer 252 causes a request for an update to be transmitted to the service provider's server computer 112, which, in cooperation with the service provider's database 118, responds with a database insert command and a set of data to be inserted into or deleted from the user network's database 158. The result is that the user network sample message database 158 is incrementally updated at each update cycle with the latest handprint changes reflected in the service provider's database 118. The batch database updates may occur at any time interval but preferably occur a short intervals, such as once per minute, in order to synchronize the two databases 118 and 158 as closely possible and to accurately classify more messages in the user network using the most up-to-date handprint information.

For security reasons the batch update process is initiated by the user network's server computer 150 so that it may remain closed to inbound connections it did not request.

Classification of Unclassified Email Messages Received by the User Network

The above description relates to the methods and apparatus of the present invention that enable a service provider to prepare sample message handprints and transmit them to a user network. Now a description will be provided of the method for using the handprint information to classify messages received by the user network.

As illustrated in FIG. 2, the software system components to support message classification in the user network 150 include a message classifier unit 156 and a sample message handprint database 158 of a similar type employed in the service provider network 110. In a preferred embodiment these components are directly integrated with a single email server computer and email server software. In this embodiment, messages are accepted by the user network email server 154 in the usual fashion, passed to the message classifier 156, measured for similarity and classified, then passed back to the email server 154 for message disposition. The use of an existing local email server 154 optimizes speed and message throughput. In a preferred embodiment the database 158 containing sample message handprints also can be stored on the same server computer 252 although it is possible in other embodimments to locate it on a separate server computer that is linked by a network connection to the server computer 152 on which the email server 154 and other components 156 and 158 reside.

In an alternative embodiment, classification of messages received by the user network 150 occurs by relaying message through a separate email server software unit that resides on a separate server computer device which also contains the other components of the present invention 154-158. The output of the separate email server software unit consists of email messages containing added message classification data. These messages then may be automatically relayed to a subsequent email server 154 residing on a separate server computer 152 to handle messages so altered in a manner reflecting user policies.

In alternative embodiment the message classifier 156 is coupled with the email server 154 but the user network copy of the database 158 is stored on a separate server computer device. An advantage of this arrangement is that multiple email servers within the same user network 150, each coupled with a copy of the message classifier 156, may share access to a single local copy of the database 158.

In another alternative embodiment the user network copy of the database 158 may serve as a master database in the user network 150 that makes its data available to distributed copies of the same database located elsewhere in the user network 150.

In another alternative embodiment the messages received by the user network may have their deliveries temporarily suspended while copies of each message are sent to a remote service provider for rendering of a message classification. After the service provider's system renders a message classification, the classification decision then may be transmitted back to the user network to enable a message handling decision according to the classification decision and according to a user policy rule.

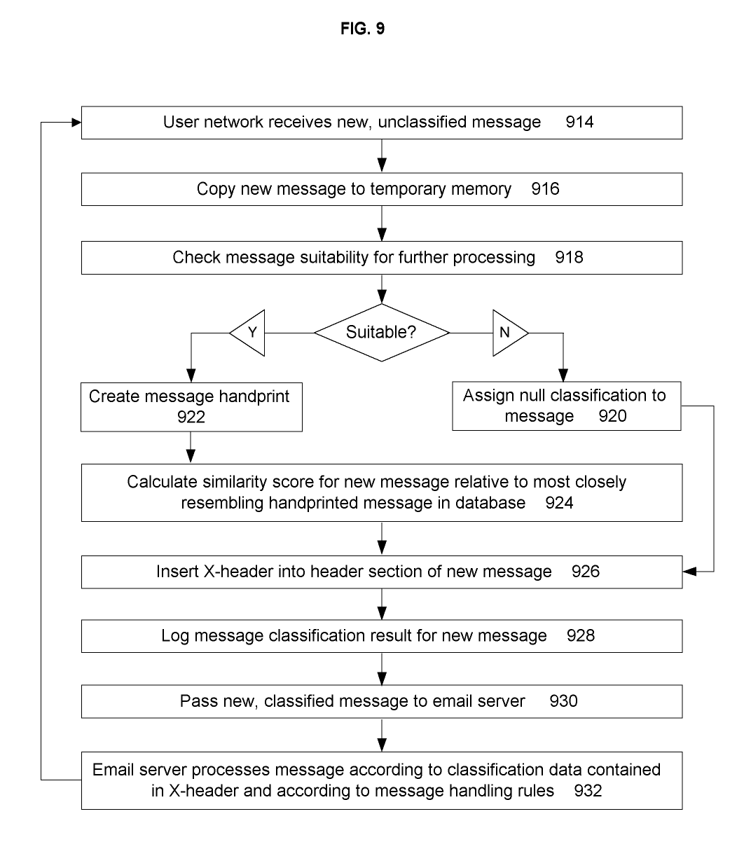

FIG. 9 illustrates the message classification and handling process operative in a user network according to the preferred embodiment.

At step 914 a new and unclassified email message is received by the email server 154 of the user network 150. The new message is passed to the message classifier 156 and is copied at step 916 to temporary memory by the message classifier 156.

At step 918 the message is subjected to an initial suitability test to determine if further message classification steps are required. For example, the size of the message may be evaluated relative to a maximum message size rule. If the message exceeds a predetermined size limit the message may be classified with a null classification at step 920 indicating that it does not require further processing. Control then passes to step 926.

If the message is judged suitable for further processing at step 918 then the message is processed to create a handprint representing the message's partial document content features at step 922 following the same steps described above for the handprinting of new sample messages. As regards handprinting of new messages in a user network, when reading the handprinting process description above as it applies to new sample messages, the reader should substitute the term “new message” wherever the term “new sample message” appears in the description.

A similarity score is calculated at step 924 to determine if the new message is similar to a sample message profiled in the user network copy of the sample message database 158. The similarity measurement process for a new message follows the same steps described above for the similarity measurement of new sample messages, except that the handprint database that is queried to support similarity comparisons is the user network copy of the database 158. As regards similarity measurement of new messages in a user network, when reading the description above as it applied to new sample messages, the reader should substitute the term “new message” wherever the term “new sample message” appears in the description. The similarity measurement process produces a similarity score value and a topic classification for the new message.

If the similarity score calculated at step 924 is less than a predetermined value, the new message is given a null classification. If the similarity score is greater than or equal to a predetermined value the message is classified according to the classification of the sample message it most closely resembles and is assigned the same classification value.

In an alternative embodiment the similarity score must equal or exceed a minimum threshold score when considering only fingers that are classified as topic-signifying in order to reliably assign a topic classification of a previously classified message to an unclassified message.

At step 926 the message classifier 156 provides its document classification output to a subsequent document processor, which in the preferred embodiment is an email server. In the preferred embodiment, the message classifier adds a line of text to the header section of the new message in a form known as an “X-header” to those skilled in the art. The X-header contains the similarity measurement score value produced by the similarity measurement process and a message classification code value. The classification code value is the same as the classification code value of the sample message that was found to bear the highest resemblance to the new message. A new message receiving a score value below a predetermined similarity threshold score value is considered to have no significant resemblance to any sample message. If no significant resemblance is found the topic code may be set to a null classification value.

In an alternative embodiment the message classifier may provide its document classification output to a subsequent document processor in a method that does not alter the content of the document.

In a preferred embodiment, the X-header also includes additional information that may be helpful to special types of users such as system administrators or the service provider. Additional information inserted into the X-header may include the record number of the most closely matching message in the handprint database upon which the similarity score was based, a database version label and a software version label. For example, a typical X-header including these features would appear as follows:

X-Message Classification Result 34.2 14 9876 2.3

where the value of “34.2” illustrates a similarity measurement score value, the value of “14” illustrates a topic code, the value of “9876” represents a sample message handprint identifier, the value of “3.4” represents a software system version identifier and the value “2.3” represents a database version number.

After a message classification step is completed, at step 928 a log file may be automatically updated to record the message classification output and metadata concerning the message such as its message ID number, sender, recipient, message size and a delivery time stamp. The log file enables reporting of system operations to be performed on both an aggregated and message-level basis.

At step 930 the message, with its modified header, is passed to the email server 154 of FIG. 2. The ultimate disposition of a message is not the responsibility of the message classification system of the present invention. A message handling decision may be made at the level of the email server 154, the email client 170, or both. For example, once a classification procedure has been completed the handling of the message may be performed at step 932 by the email server unit 154. Configuring an email server to scan the content of a message and react according to one or more deterministic rules is a procedure well known to those skilled in the art. The email server software unit may be programmed with a logical rule set that reads the similarity measurement score information and the classification information in the X-header field of the message. Optionally, the email server 154 or other document processing means that may exist as part of the overall email processing environment also may be programmed to consult any applicable user preference data for the intended recipient of a message and apply a rule for handling a message according to a set of combined conditions represented by the message content, the X-header content and one or more user preference rules for the user indicated by the recipient of the message. The rule set may include specific instructions that determine how to handle a message according to the values specified in the applicable rule or rules. For example, messages that include an X-header similarity score value above a certain level, such as 50, may be quarantined, automatically deleted or labeled as to their categories in their subject lines, while messages scoring below 50 may be automatically delivered in a normal fashion. In a preferred embodiment messages are handled according to policies established by individual users or groups of users so that the combination of scores and classification codes may be used to customize the handling of messages through the interaction of the rules and the X-header information.

In an alternative embodiment, the email server could be configured to deliver all messages to end user addressees so that client-level email processing software (typically an email reader 178) could be configured by end users to handle messages according to the values contained in the X-header or subject line. A combination of conditional responses could be configured so that score-dependent handling actions could be taken by each device. One conditional response, for example, may be to automatically alter the text of the subject line of a message to include a message classification label according to the value of the classification code in the X-header field. As may be understood by those skilled in the art, a variety of options exist for message disposition based on the X-header values beyond the description provided above.

After the new message is processed according to a message-handling rule at step 932, a next new message may be processed by the email server and message classification system.

In an alternative embodiment it is possible to have the email classification system reprocess, at predetermined intervals, any messages that have previously been classified, but have not been downloaded from the email server 154 by the end user. This feature enables classifications of unread messages to be revised if any newly received handprint information would alter the classification of a previously received message. For example, a message that initially received a null classification may subsequently be reclassified to one of a variety of bulk email classifications when a new and similar handprint to that of the subject message is received via a handprint update. Since many email messages remain on a local server for minutes or hours before their recipients download them, any opportunities to reclassify messages to reflect new handprint information can improve the overall classification accuracy rate.

Acquiring New Sample Messages from User Networks

As described above, many email messages may be identified as belonging to a certain classification based on their significant resemblance to a previously observed, handprinted and classified message. When a new form of a bulk email message is distributed, such as a spam message, inevitably there will be cases in which there is no previously observed and handprinted sample in existence that is sufficiently similar to the new message to judge the classification of the new message. Without some method of acquiring a sample, such a message will be incorrectly assigned a null classification. The practical ramification is that some spam messages would reach users who would prefer to have such messages quarantined, deleted or delivered and labeled with a correct bulk email classification. This problem can be overcome by providing a method of gathering candidate new sample documents (such as new samples of bulk email) directly from the flow of messages received by one or more user networks.

One method suggested in the prior art is collecting samples from end users that have observed unwanted bulk email messages reaching their in-boxes. Another method suggested in the prior art is collecting bulk email messages from an array of decoy email accounts. The present invention proposes an alternative method of gathering messages that are sent to users desiring email classification services and not necessarily sent to decoy accounts. The samples are collected and put to productive use before similar and unwanted messages are received by any or most recipients.

The method of the present invention of acquiring new sample messages involves detecting messages that are not similar to previously observed sample messages but are similar in a significant way to other messages recently received by one or more user network email servers. A user network server computer 152, or a collaborative network of such server computers, stores and shares recently received message handprints. Based on handprint comparisons using the method of the present invention, each newly received message that does not match a known sample message but significantly resembles a recently received message is held on the email server 154 in a quarantine directory. When any one of these messages is received by a user that permits messages that are evidently bulk email messages to be manually reviewed, such messages are selected for manual review. This permission may not be needed if the recipient account is an inactive account that is not in use by an actual user. The manual review process results in a message classification. Once a representative message is identified and classified, all members of its similarity cluster are re-compared to the newly classified message. If any of the similar messages are found to bear a measurably significant resemblance to the newly classified member of their similarity cluster, they are assigned the same classification, removed from quarantine, and passed to the email server 154 for appropriate handling. While the quarantining of messages that may or may not be spam or other bulk email messages introduces a temporary delay in the delivery of bulk email, the delay provides a valuable opportunity to properly classify messages for which a manually reviewed and classified sample does not yet exist. In a preferred embodiment a choice is provided to users of the system as to whether or not they wish to accept the possibility of a modest delay in receiving bulk email messages in order to have them classified and processed according to their bulk email preferences.

Several modifications to the system of the present invention are required to implement the described method of gathering new sample messages from one or more user networks. The database 158 is provided with a means of storing a set of recently received message handprints. The handprints may be stored in a database table that is periodically refreshed by purging any records that are older than a predetermined age limit, such as an hour. The email server 154 is modified to include a quarantined message directory that permits access by the message classifier 156.

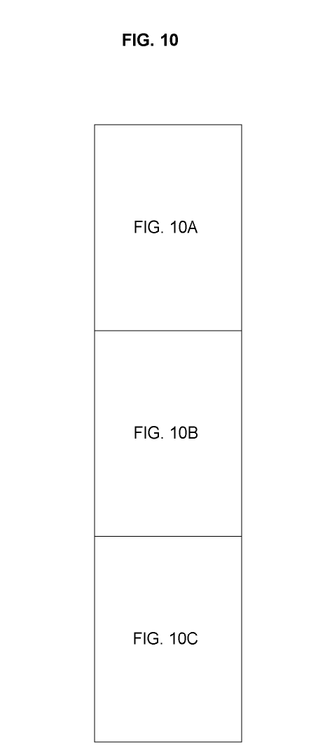

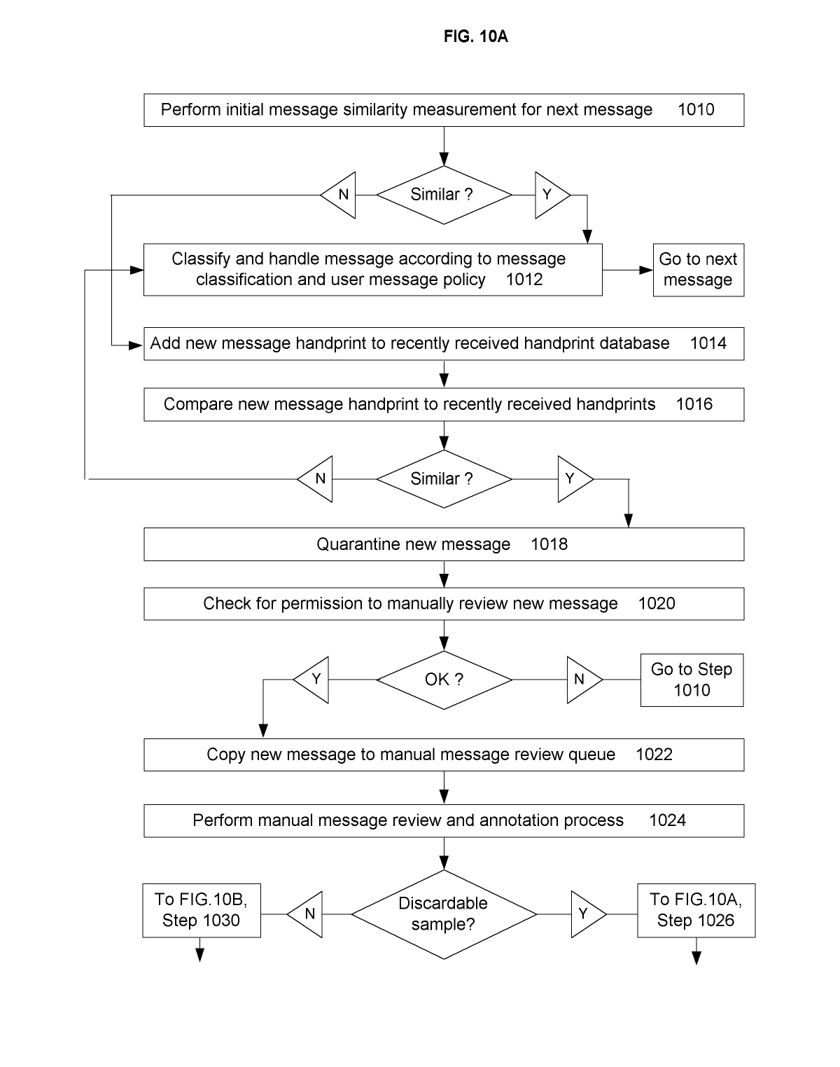

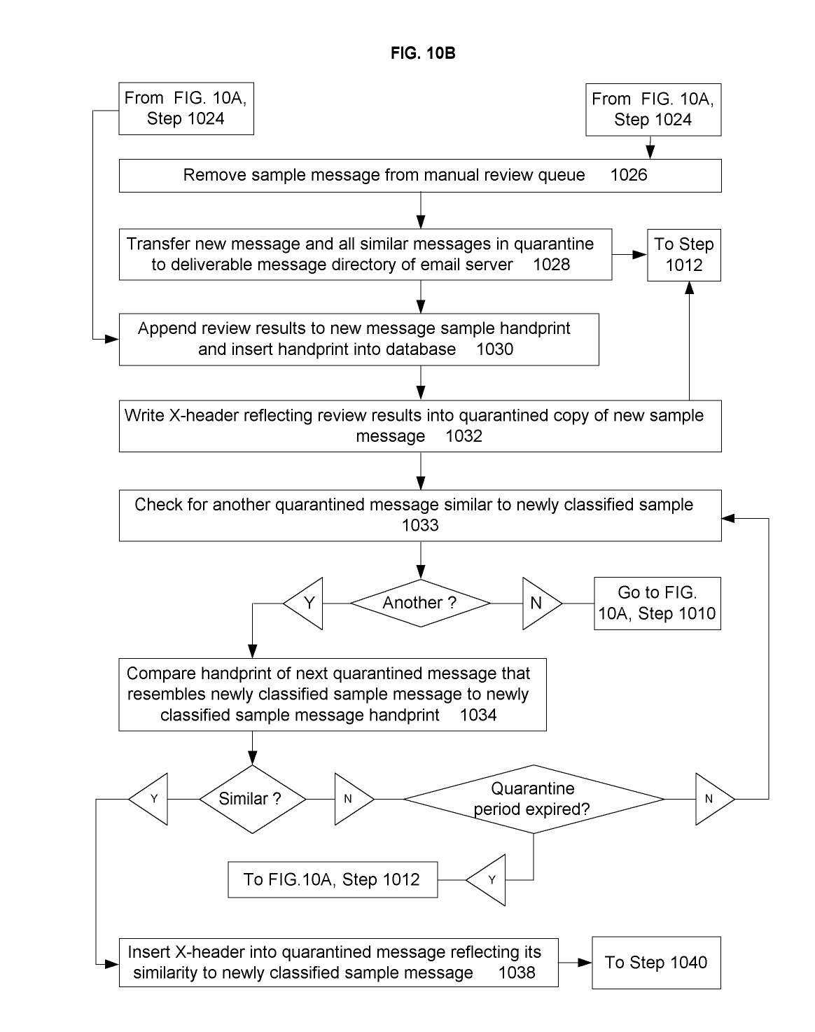

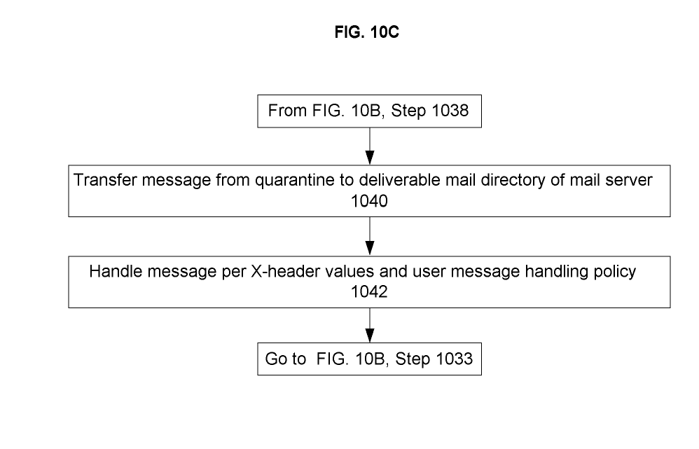

FIGS. 10A-10C illustrate the process for acquiring message samples that are evidently bulk email messages but are not sufficiently similar to previously classified messages to be classified as any particular type of email message. At step 1010 a newly received and unclassified message is evaluated by the message classifier 156 according to the teaching of the present invention. A first classification decision is rendered. If the handprint of the newly received message exactly or partially but significantly matches a previously observed and classified sample message (as determined by its handprint similarity score) then at step 1012 the message is handled according to the message handling policy for such a condition as described above. If the message does not bear a significant resemblance to any sample message then at step 1014 its handprint is added to the collection of recently received message handprints in the database 158. The new message handprint is then compared, at step 1016, to each of the recently received message handprints, using the similarity measurement processes described above.

If the new message handprint is judged to be dissimilar to all of the recently received handprints then control passes back to step 1012 and the message classification remains unchanged. The message is handled according to the original classification and according to any applicable user message handling policy.

If the new message handprint is judged to be similar to one or more recently received sample messages, this finding is taken as evidence that the message is possibly a bulk email message that should be classified. Control passes to step 1018, at which the message is placed into a temporary quarantine storage directory. The quarantine directory may be a message store located on the email server 154. The newly received message remains in quarantine until it is possible to make a classification determination via human inspection of the message or of another similar and quarantined message. If the original message which served as the basis for identifying the new message as possibly a bulk email message has not yet been downloaded by its recipient it is possible to also transfer the original message to the quarantine directory as well.

At step 1020 a check is performed to determine whether permission exists to manually review and classify the newly quarantined message. If no permission exists the message remains in quarantine and the next message is evaluated. If permission exists, then at step 1022 a copy of the newly quarantined message is transmitted to the message review queue on the service provider's server computer 112. A manual review of the message is performed at step 1024. The review process results in a classification decision.

If the message classification decision of step 1024 indicates that the new message sample is of a discardable classification, then at step 1026 the sample message copy is removed from the message review queue. At step 1028 the newly quarantined message and all similar messages in quarantine are removed from quarantine and handled, at step 1012, according to the null classification originally assigned by the primary similarity detection and classification step 1010.

If the message classification decision of step 1024 results in a determination that the newly quarantined message sample is not of a discardable classification, then at step 1030 the manual review results are appended to the new message sample's handprint and the handprint is inserted into the service provider's database 118.

At step 1032 the user network's message classifier 156 receives the results of the manual review step and writes an X-header in the header section of the newly quarantined message reflecting the manual review results. The newly quarantined message is handled, at step 1012, according to the X-header values of the secondary similarity measurement and classification values and the message handling policies of the intended message recipient.

At step 1033 a check is performed to determine whether other similar messages remain in the quarantine directory that resembled the newly classified message. If there are no such messages remaining in quarantine, control passes to step 1010.

If there are any other quarantined messages that resembled the message processed at step 1032, at step 1034 the other quarantined message is compared, on the basis of its handprint, to the modified handprint of the similar sample message that has been reviewed. This sample message handprint will have had its handprint sent by an update process to the user network database 158, enabling a comparison between the quarantined message handprint and the annotated sample handprint, thereby benefiting from additive message classification information provided by the manual review process.

If the next quarantined message is judged as not significantly similar to the newly reviewed sample message, a check is performed to determine whether the quarantine period for the quarantined message has expired. If the quarantined period has not expired, the message remains in quarantine and control passes to step 1033. If the quarantine period has expired the message is handled at step 1012 according to the primary message classification method and user message handling policy.

If the next quarantined message is judged as significantly similar to the newly reviewed sample message, at step 1038 the message classifier 156 inserts an X-header into the quarantined message's header section reflecting the results of the secondary similarity measurement and classification process. The message is then removed at step 1040 from the quarantine directory. At step 1042 the message is handled according to the secondary message classification method's result and user message handling policy. Control passes to step 1033, where a check is performed to determine whether another quarantined message exists that was originally judged similar to the newly reviewed sample message. If there are no more such quarantined messages control passes to step 1010 when a next message is received for processing. If there is another quarantined message that bore a significant similarity to the newly reviewed sample message, control passes to step 1034. The handprint of the quarantined message is compared to the handprint of the newly reviewed sample message. This cycle repeats until all quarantined messages that matched the newly reviewed sample message are re-evaluated against the newly reviewed message's updated handprint. After all such quarantined messages are evaluated and handled processing terminates and a next newly received message may be processed beginning at step 1010.

In an alternative embodiment the similarity measurement process applied in the secondary evaluation can be limited to comparing link fingers or link subfingers in order to gauge potential message similarity. An advantage of this less restrictive partial matching test is that it can detect potentially significant partial matches even when substantial variation in the content of compared messages exists.

In an alternative embodiment the list of link fingers or subfingers used to identify potential spam or bulk email messages in the secondary evaluation process may be augmented by a process of automatically searching for related links among HTML documents on remote servers when such documents are included as call-to-action link fingers in confirmed spam email messages. In some cases, spam message senders store duplicated HTML documents in the same or similar file directories on a single Web server. By probing a Web site that is referenced by such links, the exact file locations and therefore the exact link identifiers of varied but related call-to-action links can be discovered. These related links can be used to assist identifying previously unseen spam messages. When such HTML documents are downloaded and confirmed as significant or identical copies of documents linked to confirmed spam messages, these newly discovered links can be added to a list of call-to-action links that can help identify suspicious messages to be quarantined.

In an alternative embodiment, handprints representing recently received messages may be forwarded from multiple user networks to the service provider network 110 so that the service provider may compile a master list of recently received handprints. The service provider then may distribute any new additions to the aggregated list of recently received message handprints to each user network 110 so that the aggregated data could be used to provide a more comprehensive listing of recently received handprints than any single user network 110 might be able to compile without the aid of collaborative observation.

### Conclusion, Ramifications, and Scope

Our invention solves three general problems that are not satisfactorily addressed by the prior art.

The first problem solved by the present invention is that of accurately detecting semantic document similarity despite the potentially heavy intermixing of significant and duplicated content with insignificant and dynamically altered obfuscation content in a group of documents, such as email messages. Our invention improves the accuracy of the case-based approach underlying fingerprinting through a combination of human assistance in determining how the content of sample cases should be interpreted and a highly refined fingerprint-based similarity detection algorithm that reliably segregates potentially significant content from insignificant content. The advantageous incorporation of human assistance in judging the contents of sample document cases enables a correct determination of document classifications and classifications of individual features comprising a document, helping overcome the problem of noise or content camouflage that interferes with automated pattern recognition. In effect, the method enables accurate identification of all of a document's recurring content that cannot be reliably identified by automated means alone.

The similarity detection algorithm incorporates selective parsing and stripping or suppression of insignificant document content using a non-semantic model of document feature types and associates manually derived metadata with sample messages and their features in order to more intelligently define each sample in terms of its significant and non-variable content.

The result of applying the above procedures is an identification of a maximum amount of significant content that characterizes messages composing a bulk email broadcast, even in cases where much of the content is drastically altered from one functional copy to another through inclusion by a message author of obfuscating content.

The algorithm further incorporates an unbiased means of measuring the similarity of unclassified documents to previously classified sample documents using a shared-significant content ratio rather than a probabilistic estimation or a ratio of shared digest values.

The second problem solved by the present invention is that of automatically classifying documents at a greater degree of topical granularity than a binary scheme such as simply “junk” and “not junk” to support differing opinions as to what document topics constitute “junk” for different individual users or groups of users. Our invention provides a means of acquiring additive topical information associated with samples that, when incorporated into the similarity detection algorithm, can be used to automatically determine the topic of an unclassified document on the basis of its partial or full resemblance to the significant elements of a sample message that have been topically classified through a manual process. Documents, such as email messages, may be automatically classified and handled according to any of a wide variety of topics, supporting customization of document classification for different users of the system.

A third general problem solved by the present invention is that of collecting samples of electronically distributed documents, such as email messages, without burdening end users so that automatic classification processes may advantageously have the most comprehensive and timely samples on which to evaluate previously unclassified messages. Our invention overcomes this problem by storing a record of previously observed message handprints, comparing unclassifiable messages to other unclassifiable messages to detect unclassified message clusters, deferring their delivery until a classification can be made in at least one representative case via manual intervention, classifying the members of the cluster on the basis of the classification assigned to the individual case and providing a classification label for each member of the cluster so that subsequent systems can handle each member of the cluster according to group-level or individual-level policies.

1. A method for automatically classifying unclassified documents, comprising the steps of:
a. processing, on a first processing system, a plurality of sample documents to identify a plurality of sample document feature sets of potentially duplicated and significant sample document features, whereby each sample feature set is associated with one of said plurality of sample documents;
b. electronically associating with each of said plurality of sample document feature sets a set of at least one manually selected document annotation values, whereby said document annotation values each represent a subjective classification of one of said plurality of sample documents with which said document annotation values are individually associated;
c. electronically associating with each of said plurality of sample document feature sets a set of at least one manually selected document feature annotation values, whereby said document feature annotation values each represent a subjective classification of one of a plurality of sample document features with which said document feature annotation values are individually associated;
d. processing, on a second processing system, an unclassified document to identify a set of potentially duplicated and significant unclassified document features;
e. comparing, on said second processing system, said set of potentially duplicated and significant unclassified document features to each of said sample document feature sets, inclusive of said document annotation values and said document feature annotation values associated with each of said sample document feature sets;
f. determining which of said plurality of sample document feature sets shares in common with any of the features comprising an unclassified document feature set a largest weighted quantity of features subjectively classified and annotated as significant, whereby a most significantly resembling sample document may be determined; and
g. outputting a significant similarity measurement value and a classification value for said unclassified document according to a weighted ratio of matching significant features of said most significantly resembling sample document as compared to all of said significant features of said most significantly resembling sample document.

2. The method of claim 1 wherein the documents to be classified are electronic messages such as email messages, wireless text messages, or instant messages.

3. The method of claim 1 wherein said documents to be classified are electronic resume files.

4. The method of claim 1 wherein said documents to be classified are HTML files or Web page files.

5. The method of claim 1 wherein said documents to be classified are text files, regardless of the existence or lack of formatting information.

6. A method for automatically classifying unclassified documents, comprising the steps of:
a. registering, on a first processing system, each of said plurality of sample documents representative of at least one of a plurality of document classifications;
b. parsing each of said plurality of sample documents into at least one of a plurality of partial document content features according to a set of document parsing rules;
c. selectively decoding, removing and discarding from each of said sample documents, according to a set of document content decoding and removal rules, at least one of a plurality of said partial document content features, or portions of partial document content features, whereby any of said partial document content features that are considered insignificant for document classification purposes or are considered to be obfuscating content that exists to subvert said document classification process may be removed;
d. determining and recording, by a manual document review and electronic annotation process, at least one of a plurality of subjective classifications of each of said plurality of sample documents, whereby at least one of a plurality of subjective classification labels are associated with each of said sample documents;
e. determining and recording, by a manual document review and electronic annotation process, at least one of a plurality of subjective classifications of each of said plurality of partial document content features of each of said sample documents, whereby at least one of a plurality of subjective classification labels are associated with each of said sample document's partial content features;
f. storing for each annotated sample document, on said first processing system, an annotated sample document record, inclusive of said sample document's content, said set of partial document content features, a set of unique digests of each partial content feature, at least one of said document annotation values, at least one of said plurality of said document feature annotation values, and other document attribute data;
g. storing, on said second processing system, a copy of each of said annotated sample document records;
h. parsing, on a second processing system, an unclassified document into at least one of said plurality of partial document content features and selectively removing and discarding portions of said unclassified document's content in a manner consistent with steps 6b and 6c above;
i. querying said second processing system using said unclassified document's residual partial document content features or unique digests thereof and returning a list of all partially resembling sample documents which share in common at least one of a plurality of matching partial document content features with said unclassified document, subject to a requirement that any of said partial document content features that match are also subjectively classified and annotated as significant in any of said sample documents.
j. calculating a set of ratios of characters comprising said unclassified document's partial document content features that match said significant partial document content features contained in each of said partially resembling sample documents in said set of partially matching sample documents, as compared to a count of total characters comprising said significant partial document content features found in said partially resembling sample documents, resulting in a set of significant partial document content feature similarity scores;
k. comparing the highest of said scores to a predetermined document similarity threshold value; and
l. assigning said unclassified document said document similarity score and a classification value matching said subjective classification of said most closely resembling sample document if said document similarity score exceeds said predetermined threshold value, otherwise assigning said unclassified document a null or non-matching classification.

7. The method of claim 6 wherein said plurality of partial document content features are comprised of non-overlapping character sequences or subsequences.

8. The method of claim 6 wherein said plurality of partial document content features may be limited in length, including a minimum and maximum character length.

9. The method of claim 6 wherein said plurality of partial document content features may be adjusted in length by truncation and concatenation with an adjacent partial document content feature of a same type.

10. The method of claim 6 wherein index values may be associated with said plurality of partial document content features representing an order of appearance of said partial document content features in said document.

11. The method of claim 6 wherein said partial document content features may be comprised of character sequences or subsequences separated by line break symbols, formatting tags and arbitrarily selected boundary types.

12. The method of claim 6 wherein one of a plurality of partial document content feature types may be defined as any character sequence or subsequence conforming to a pattern of a hypertext link.

13. The method of claim 6 wherein one of said plurality of partial document content feature types may be defined as any character sequence conforming to a pattern of a consistently recognizable portion of a hypertext link.

14. The method of claim 6 wherein one of said plurality of partial document content feature types may be defined as an attached file's contents.

15. The method of claim 6 wherein one of said plurality of partial document content feature types may be defined as a linked file's contents.

16. The method of claim 6 wherein one of said plurality of partial document content feature types may be defined as an attached file's metadata.

17. The method of claim 6 wherein one of said plurality of partial document content feature types may be defined as a linked file's metadata.

18. The method of claim 6 wherein one of said plurality of partial document content feature types may be defined as a call-to-action character sequence or subsequence.

19. The method of claim 6 wherein one of said plurality of partial document content feature types may be defined as an insignificant character sequence or subsequence.

20. The method of claim 6 wherein one of said plurality of partial document content feature types may be defined as an executable program code character sequence or subsequence.

21. The method of claim 6 wherein more than one method of partitioning said document into partial document content features may be used to produce more than one set of partial document content features, whereby more than one method of measuring document similarity may be employed.

22. The method of claim 6 wherein decoding of any encoded partial document content features uses a distinct set of decoding rules for said partial document content features of specified types and of specified document feature encoding types.

23. The method of claim 6 wherein decoding and removal of potentially insignificant or obfuscating content from any partial document content features uses a distinct set of content removal rules for said partial document content features of specified types.

24. The method of claim 6 wherein said calculation of said similarity score ratio employs weights for each of said partial document content features that are proportional to the number of text characters comprising each of said partial document content features.

25. The method of claim 6 wherein the numbers of characters used to assign weights for partial document content features exclude characters which have been removed.

26. The method of claim 6 wherein a plurality of similarity threshold values may be applied to determine document similarity, whereby a specific similarity threshold value may be applied conditionally, depending upon an attribute of said document, such as said document's total character length.

27. The method of claim 6 wherein a first unclassified document having fewer than a predetermined number of characters is evaluated against a higher similarity score threshold value than a second unclassified document having a number of characters greater than a predetermined number of characters.

28. A method for automatically identifying in a document a set of potentially duplicated and significant document features, comprising the steps of:
a. parsing said document into at least one of a plurality of said partial document content features according to a set of document parsing rules;
b. selectively removing and discarding from said sample document, according to a set of document content removal rules, at least one of a plurality of said partial document content features, or portions of said partial document content features, that are considered insignificant for document classification purposes or are considered to be obfuscating content that exists to subvert said document classification process, whereby any remaining content may be considered potentially duplicated and significant.

29. The method of claim 28 comprising the step of removing partial document content features whereby content of different partial document content features types are removed according to different rules and at different stages in a sequence of content removal steps, whereby content removal rules may be invoked conditionally depending upon said stage of processing and said partial document content feature type to be processed.

30. A method of excluding from consideration in a document similarity measurement process semantically insignificant or obfuscating partial document content features contained within sample documents, comprising the steps of:
a. selecting and recording, by a manual document review and electronic annotation process, at least one of a plurality of subjective classification values of each of said plurality of partial document content features of said sample documents, wherein at least one of said plurality of subjective classification values are bound to a record of each of said sample documents' partial content features;
b. assigning a numerical weight of zero to any of said partial document content features which are labeled with a classification value indicating that said partial document content features are of a semantically insignificant or obfuscating content classification; and
c. including said zero-weighted classification values in said similarity measurement process steps that apply said weights to be assigned to each of said partial document content features comprising said sample documents.

31. A method of preventing the submission of a new sample document to a manual document review and annotation processing system when said new sample document is an exact or significantly partial duplicate of a previously submitted, reviewed and retained sample document, comprising the steps of:
a. parsing said new sample document into at least one of said plurality of partial document content features according to said set of document parsing rules;
b. selectively removing and discarding from said new sample document, according to said set of document content removal rules, at least one of a plurality of said partial document content features, or portions of said partial document content features, that are considered insignificant for document classification purposes or are considered to be obfuscating content that exists to subvert said document classification process;
c. querying said first processing system using said new sample document's residual partial document content features or unique digests thereof and returning a list of all partially resembling existing sample documents which share in common at least one of a plurality of matching partial document content features with said new sample document, subject to said requirement that any of said partial document content features that match are also subjectively classified and annotated as significant in any said existing sample documents;
d. calculating a set of said ratios of characters comprising said new sample document's partial document content features that match said significant partial document content features contained in each of said partially resembling existing sample documents, as compared to said total characters comprising said significant partial document content features found in said partially resembling sample documents, resulting in a set of significant partial document content feature similarity scores;
e. comparing the highest of said scores to said predetermined document similarity threshold value; and
f. accepting submission of said new sample document if said similarity score falls below a predetermined similarity score threshold value; and
g. discarding said new sample document if said similarity score equals or exceeds said predetermined similarity score threshold value, whereby said new sample document is excluded from said manual document review process due to its significant measured similarity to one of said plurality of existing sample documents.

32. A method of calculating a measure of similarity between two sets of partial document content features that adjusts for differences in relative length of partial document content features, comprising the steps of:
a. determining which of said set of partial document content features of a first document match any of said set of partial document content features of a second document, wherein said partial document content features are extracted from each of said documents according to the same method;
b. calculating a similarity score, wherein a similarity score is a ratio of said number of characters contained in matching partial document content features divided by said total number of characters in all of said partial document content features comprising said first document.

33. The method of claim 32 comprising the step of detecting and deleting any of said partial document content features that mach one of a plurality of common partial document content features.

34. The method of claim 32 comprising the step of removing partial document content features, or portions thereof, according to a set of content removal rules that are dependent on said type of partial document content feature, before counting characters contained in said partial document content feature.

35. A method of automatically determining the topical classification of a document, comprising the steps of:
a. determining that at least a minimum quantity of partial document content features of an unclassified document match any of a set of said partial document content features of a previously classified document;
b. determining that at least a minimum weighted relative quantity of said matching partial document content features of said previously classified document are individually classified as being indicative of said previously classified document's topical classification;
c. assigning a topical classification of said previously classified document to said unclassified document.

36. The method of claim 35 wherein the method of weighting said quantity of partial document content features is based on a count of characters comprising each of said partial document content features.

37. The method of claim 35 wherein said count of characters comprising each of said partial document content features is calculated after completing a partial document content removal process to eliminate insignificant or obfuscating content.

38. A method of selecting and collecting unclassified documents distributed in a network that may serve as samples of similar documents to be classified, comprising the steps of:
a. storing, for each unclassified or non-specifically classified document distributed in a network, profiles comprised of each document's partial document content features;
b. deriving, for a first new document distributed within a network, a profile comprised of said first new document's partial document content features;
c. calculating a measure of similarity of said first new document's profile relative to each of said existing unclassified or non-specifically classified document profiles;
d. classifying as partially duplicated said first new document for which at least a predetermined minimum measure of similarity is calculated with respect to its profile as compared to any of said existing unclassified or non-specifically classified document profiles;
e. retaining as a candidate new sample document said first partially duplicated document copy and its profile.

39. The method of claim 1 wherein said sample documents are collected and processed by a service provider.

40. The method of claim 1 wherein said sample documents are collected and processed by an administrator of a user network.

41. The method of claim 1 wherein said manual review of said sample document results in recording a subjective classification of any of said partial document content features that are insignificant for document similarity detection purposes.

42. The method of claim 1 wherein said manual review of said sample document results in recording a subjective classification of any of said partial document content features that are indicative of said sample document's topic classification.
